(19) United States
(12) Patent Application Publication
(10) Pub. No.: US 2007/0212627 A1
(43) Pub. Date: Sep. 13, 2007

(54) ELECTROPHOTOGRAPHIC PHOTORECEPTOR AND METHOD OF PREPARING THE PHOTORECEPTOR, AND IMAGE FORMING METHOD, IMAGE FORMING APPARATUS AND PROCESS CARTRIDGE THEREFOR USING THE PHOTORECEPTOR

(76) Inventors: Yoshiki Yanagawa, Numazu-shi (JP); Yoshiaki Kawasaki, Susono-shi (JP); Tetsuro Suzuki, Fuji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/685,441

(22) Filed: Mar. 13, 2007

(30) Foreign Application Priority Data
Mar. 13, 2006 (JP) 2006-066947

(51) Int. Cl. G03G 5/047; G03G 5/147

(52) U.S. Cl. 430/58.75; 430/73; 430/66

(57) ABSTRACT

An electrophotographic photoreceptor formed of an electroconductive substrate and a photosensitive layer located overlying the electroconductive substrate, wherein the photosensitive layer contains units obtained from a tri- or more functional radical polymerizable monomer having no charge transport structure and a radical polymerizable compound having a charge transport structure and the photosensitive layer has a layer film density of from 1.0 to 1.4 g/cm³.

### BACKGROUND OF THE INVENTION

1. Field of the Invention

The present invention relates to an electrophotographic photoreceptor and a method of preparing the photoreceptor and to an image forming method, an image forming apparatus and a process cartridge therefor using the photoreceptor.

2. Discussion of the Background

Recently, organic photoreceptors (OPCs) have been widely used instead of inorganic photoreceptors for copiers, facsimiles, laser printers and their complex machines because of their good performances and advantages. Specific examples of the reasons include (i) optical properties such as a wide range of light absorbing wavelength and a large amount of light absorbance; (ii) electrical properties such as high sensitivity and stable chargeability; (iii) choice of the materials; (iv) good manufacturability; (v) low cost; (vi) non-toxicity, etc.

On the other hand, as image forming apparatuses become smaller, photoreceptors have smaller diameters recently. In addition, photoreceptors are required to have high durability as image forming apparatuses produce images at a higher speed and are free from maintenance. In this respect, the organic photoreceptor typically has a soft surface layer mainly formed from a low-molecular-weight charge transport material and an inactive polymer, and therefore the organic photoreceptor typically has a drawback of being mechanically abraded with an image developer and a cleaner with ease when used repeatedly in the electrophotographic process. In addition, as toner particles have smaller particle diameters due to requirements for high-quality images, cleaning blades need to have higher rubber hardness and higher contact pressure for the purpose of increasing cleanability, which also accelerates the abrading of photoreceptors. Such abrasion of photoreceptors deteriorates electrical properties thereof such as sensitivity and chargeability, and cause abnormal images such as image density deterioration and background fouling. When a photoreceptor is locally abraded, images having black stripes due to defective cleaning are produced. At present, photoreceptors are exchanged because of the abrasion and damage.

Therefore, it is indispensable to decrease the abrasion amount of the organic photoreceptor so as to have high durability. This is one of the most pressing issues to solve In this field.

As methods of improving the abrasion resistance of a photoreceptor, (1) Published Unexamined Japanese Patent Application No. 56-48637 discloses a photoreceptor using a hardening binder in its surface layer; (2) Published Unexamined Japanese Patent Application No. 64-1728 discloses a photoreceptor using charge transport polymer material; and (3) Published Unexamined Japanese Patent Application No. 4-281461 discloses a photoreceptor having a surface layer wherein an inorganic filler is dispersed. The photoreceptor using a hardening binder of (1) tends to increase a residual potential and decrease image density because of poor solubility of the binder with a charge transport material and impurities such as a polymerization initiator and an unreacted residual group. The photoreceptor using charge transport polymer material of (2) and the photoreceptor having a surface layer wherein an inorganic filler is dispersed of (3) have abrasion resistance to some extent, but that resistance is not fully satisfactory. Further, the photoreceptor having a surface layer wherein an inorganic filler is dispersed of (3) tends to increase a residual potential and decrease image density because of a trap present on the surface of the inorganic filler. None of the photoreceptors of (1) to (3) have fully satisfactory integrated durability such as electrical durability and mechanical durability.

To improve the abrasion resistance of the photoreceptor of (1), Japanese Patent No. 3262488 discloses a photoreceptor including hardened urethane acrylate. However, although disclosing that the photosensitive layer includes the hardened urethane acrylate, Japanese Patent No. 3262488 only discloses that a charge transport material may be included therein and does not disclose specific examples thereof. When a low-molecular-weight charge transport material is simply included in a photosensItive layer, the low-molecular-weight charge transport material is not soluble with the hardened urethane acrylate and the low-molecular-weight charge transport material separates out, causing deterioration of mechanical strength of the resultant photoreceptor such as a crack. In addition, Japanese Patent No. 3262488 discloses that a polycarbonate resin is included in the photosensitive layer to improve the solubility. However, the content of the hardened urethane acrylate decreases, resulting in insufficient abrasion resistance of the photoreceptor. A photoreceptor not including a charge transport material in its surface layer, which is thin against deterioration of potential of the irradiated part, has a short life. In addition, the charged potential thereof has poor stability against the environment.

As an abrasion resistance technology of a photosensitive layer in place of these technologies, Japanese Patent No 3194392 discloses a method of forming a charge transport layer using a coating liquid formed from a monomer having a carbon-carbon double bond, a charge transport material having a carbon-carbon double bond and a binder resin. The binder resin includes a binder resin having a carbon-carbon double bond and reactivity with the charge transport material, and a binder resin having neither a carbon-carbon double bond nor reactivity with the charge transport material. The photoreceptor has good abrasion resistance and electrical properties. However, when a binder resin not having a reactivity with a charge transport material, such as an acrylic polymer, a styrene polymer, an acrylic styrene copolymer, a polyester resin, a polycarbonate resin and an epoxy resin, the bonding amount between the monomer having a carbon-carbon double bond and the charge transport material having a carbon-carbon double bond decreases, resulting in insufficient crosslink density of the photosensitive layer. Further, since the binder resin itself does not have toughness the resultant photosensitive layer does not have satisfactory abrasion resistance.

Published Unexamined Japanese Patent Application No. 2000-66425 discloses a photosensitive layer including a hardened positive hole transport compound having two or more chain polymerizable functional groups in the same molecule. However, since the photosensitive layer includes a bulky positive hole transport material having two or more chain polymerizable functional groups, a distortion appears in the hardened compound and internal stress increases to cause roughness and a crack of the surface layer, resulting in insufficient durability of the resultant photoreceptor. A method of controlling the quantity of a solvent before polymerizing is not described therein, and filming density is not improved occasionally, resulting in insufficient abrasion resistance. A dense crosslinked film is not formed, and the resultant photoreceptor does not have sufficiently stable electrical properties due to an oxidizing gas or humidity and produces residual images occasionally. Namely, quality images are not stably produced for long periods.

Published Unexamined Japanese Patent Applications Nos. 2004-302450, 2004-302451and 2004-302452 disclose a crosslinked charge transport layer in which a tri- or more functional radical polymerizable monomer having no charge transport structure and a radical polymerizable compound having a charge transport structure are hardened, wherein the radical polymerizable compound having a charge transport structure improves mechanical and electrical durability of the layer and prevents the layer from being cracked. However, the filming density is not fully improved occasionally, resulting in insufficient abrasion resistance. A dense crosslinked film is not formed, and the resultant photoreceptor does not have sufficiently stable electrical properties due to an oxidizing gas or humidity and produces residual images occasionally. Namely, quality images are not stably produced for long periods.

Because of these reasons, a need exists for a photoreceptor having good durability and stable electrical properties against environmental variations, and produces high-quality images for long periods.

### SUMMARY OF THE INVENTION

Accordingly, an object of the present invention is to provide a photoreceptor having good durability and stable electrical properties against environmental variations, and produces high-quality images for long periods.

Another object of the present invention is to provide a method of preparing the photoreceptor.

A further object of the present invention is to provide an image forming method using the photoreceptor.

Another object of the present invention is to provide an image forming apparatus using the photoreceptor.

A further object of the present invention is to provide a process cartridge therefor, using the photoreceptor.

These objects and other objects of the present invention, either individually or collectively, have been satisfied by the discovery of an electrophotographic photoreceptor, comprising:

an electroconductive substrate, and

a photosensitive layer located overlying the electroconductive substrate, wherein the photosensitive layer comprises units obtained from:
a tri- or more functional radical polymerizable monomer having no charge transport structure; and
a radical polymerizable compound having a charge transport structure,

wherein the photosensitive layer has a layer film density of from 1.0 to 1.4 g/cm³.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGS. 1A and 1B are schematic views illustrating cross-sections of layer structure embodiments of the electrophotographic photoreceptor of the present invention;

FIGS. 2A and 2B are schematic views illustrating cross-sections of other layer structure embodiments of the electrophotographic photoreceptor of the present invention;

FIG. 3 is a schematic view illustrating a partial cross-section of an embodiment of the image forming apparatus of the present invention; and

FIG. 4 is a schematic view illustrating an embodiment of the process cartridge of the present invention.

### DETAILED DESCRIPTION OF THE INVENTION

The present invention provides a photoreceptor having good durability and stable electrical properties against environmental variations, and produces high-quality images for long periods.

The photoreceptor of the present invention includes a tri- or more functional radical polymerizable monomer in its surface layer, which develops a three-dimensional network, and therefore the surface layer becomes a very hard crosslinked layer having high crosslink density and high abrasion resistance. Meanwhile when only a monomer having less radical polymerizable functional groups is used, the crosslinkage therein becomes poor and the crosslinked surface layer does not have a noticeable abrasion resistance. When a polymer material is included therein the development of the three-dimensional network is impaired and the crosslinkage therein deteriorates resulting in less abrasion resistance than that of the present invention. Further the polymer material has poor compatibility with a hardened material produced by a reaction between the polymer material and the radical polymerizable constituents, i.e., the radical polymerizable monomer and the radical polymerizable compound having a charge transportable structure, resulting in a layer separation causing a local abrasion and a damage on the surface

The crosslinked surface layer of the present invention including the tri- or more functional radical polymerizable monomer having no charge transport structure and the radical polymerizable compound having a charge transport structure, which are hardened at the same time in a short period of time (typically in 24 hrs) to form a crosslinked bonding having high hardness has improved durability. Further improvement of the hardening speed can form a smooth surface layer and good cleanability thereof can be maintained for long periods. Further, a uniform crosslinked film with less distortion can be formed therein. In addition, including the radical polymerizable compound having a charge transport structure, the crosslinked layer has stable electrical properties for long periods. When the crosslinked surface layer includes a low-molecular-weight charge transport material not having a functional group, the low-molecular-weight charge transport material separates out and becomes clouded, and mechanical strength of the crosslinked surface layer deteriorates.

In the crosslinked surface layer of the present invention having a layer film density of from 1.0 to 1.4 g/cm³, a three-dimensional network is fully developed and the resultant crosslinked surface layer has quite high hardness, elasticity and abrasion resistance and at the same time, can lower the permeation of gases such as ozone, nitrogen oxide and moisture vapor affecting electrophotography. Therefore, the resultant electrophotographic photoreceptor has improved environmental stability and high reliability, i.e., has improved abrasion resistance without crack, stable electrical properties for long periods, and produces high-quality images for long periods.

The electrophotographic photoreceptor of the present invention, which is formed of an electroconductive substrate and a photosensitive layer formed by polymerizing a tri- or more functional radical polymerizable monomer having no charge transport structure and a radical polymerizable compound having a charge transport structure, wherein the photosensitive layer has a layer film density of from 1.0 to 1.4 g/cm³, can have abrasion resistance, stable electrical properties, improved environmental stability and produce high-reliability and high-quality images for long periods.

Next, constituents of a coating liquid for forming the crosslinked surface layer will be explained.

The tri- or more functional monomers having no charge transport structure mean monomers which have three or more radical polymerizable groups and which do not have a charge transport structure (such as a positive hole transport structure (e.g., triarylamine, hydrazone, pyrazoline and carbazole structures); or an electron transport structure (e.g., condensed polycyclic quinine structure, diphenoquinone structure, a cyano group and a nitrogroup)). As the radical polymerizable groups, any radical polymerizable groups having a carbon-carbon double bond can be used. Suitable radical polymerizable groups include the following 1-substituted ethylene groups and 1,1-substituted ethylene groups.

Specific examples of the 1-substituted ethylene groups include functional groups having the following formula:
CH₂=CH—X₁—
wherein X₁ represents an arylene group (such as a phenylene group and a naphthylene group), which optionally has a substituent, a substituted or unsubstituted alkenylene group, a —CO— group, a —COO— group, a-CON (R¹⁰) group (wherein R¹⁰ represents a hydrogen atom, an alkyl group (e.g., a methyl group, and an ethyl group), an aralkyl group (e.g., a benzyl group, a naphthylmethyl group and a phenylene group) or an aryl group (e.g., a phenyl group and a naphthyl group)), or a —S— group.

Specific examples of the substituents include, but are not limited to, a vinyl group, a styryl group, 2-methyl-1,3-butadienyl group, a vinylcarbonyl group, acryloyloxy group, acryloylamide, vinyl thioether, etc.

Specific examples of the 1,1-substituted ethylene groups include functional groups having the following formula:
CH₂=C(Y)—X₂—
wherein Y represents a substituted or unsubstituted alkyl group, a substituted or unsubstituted aralkyl group, a substituted or unsubstituted aryl group (such as phenyl and naphthyl groups), a halogen atom, a cyano group a nitro group, an alkoxyl group (such as methoxy and ethoxy groups) or a —COOR₃₁ group (wherein R₃₁ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a —CONR₃₂R₃₃ group (wherein each of R₃₂ and R₃₃ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups); and X₂ represents a group selected from the groups mentioned above for use in X₁ and an alkylene group, wherein at least one of Y and X₂ is an oxycarbonyl group, a cyano group, an alkenylene group or an aromatic group.

Specific examples of the substituents include, but are not limited to, an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents for use in the groups X₁, X₂ and Y include, but are not limited to, halogen atoms a nitro group, a cyano group alkyl groups (such as methyl and ethyl groups), alkoxy groups (such as methoxy and ethoxy groups), aryloxy groups (such as a phenoxy group), aryl groups (such as phenyl and naphthyl groups), aralkyl groups (such as benzyl and phenethyl groups), etc.

The acryloyloxy groups and methacryloyloxy groups are preferably used as the radical polymerizable functional groups. Radical polymerizable monomers having three or more radical polymerizable functional groups i.e., acryloyloxy groups or methacryloyloxy groups, are preferably used in terms of improving the abrasion resistance of the resultant surface layer.

Compounds having three or more acryloyloxy groups can be prepared by subjecting (meth)acrylic acid (salts), (meth) acrylhalides and (meth)acrylates which have three or more hydroxyl groups, to an ester reaction or an ester exchange reaction. The three or more radical polymerizable groups included in a radical polymerizable tri- or more functional monomer are the same as or different from the others therein.

Specific examples of the radical polymerizable tri- or more functional monomers include, but are not limited to, trimethylolpropane triacrylate (TMPTA) trimethylolpropane trimethacrylate, trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, lycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol tetraacrylate, alkylated dipentaerythritol triacrylate, dimethylolpropane tetraacrylate (DTMPTA), pentaerythritol ethoxytriacrylate, ethyleneoxy-modified triacryl phosphate, 2,2,5,5-tetrahydroxymethylcyclopentanone tetraacrylate, etc. These monomers are used alone or in combination. These are modified because the viscosities thereof are decreased to be easily handled.

In order to form a dense crosslinked network in the crosslinked surface layer, the ratio (Mw/F) of the molecular weight (Mw) of the tri- or more functional monomer to the number of functional groups (F) included in a molecule of the monomer is preferably not greater than 250. When the number is too large, the resultant protective layer becomes soft and thereby the abrasion resistance of the layer slightly deteriorates. In this case, it is not preferable to use only one monomer having a functional group having a long chain group such as ethylene oxide, propylene oxide and caprolactone.

The content of the unit obtained from the tri- or more functional monomers in the crosslinked surface layer is preferably from 20 to 80% by weight, and more preferably from 30 to 70% by weight based on the total weight of the surface layer. When the content is too low, the three dimensional crosslinking density is low, and thereby good abrasion resistance cannot be imparted to the surface layer. In contrast, when the content is too high, the content of the charge transport compound decreases, good charge transport property cannot be imparted to the surface layer. In order to balance the abrasion resistance and charge transport property of the crosslinked surface layer, the content of the unit obtained from the tri- or more functional monomers in the surface layer is preferably from 30 to 70% by weight.

The radical polymerizable compound having a charge transport structure for use in the present invention is a compound which has a positive hole transport structure such as triarylamine, hydrazone, pyrazoline and carbazole or an electron transport structure such as condensed polycyclic quinone, diphenoquinone, a cyano group or an electron attractive aromatic ring having a nitro group, and has a radical polymerizable functional group. Specific examples of the radical polymerizable functional group include, but are not limited to, the above-mentioned radical polymerizable monomers, and particularly the acryloyloxy groups and methacryloyloxy groups are effectively used. In addition, a triarylamine structure is effectively used as the charge transport structure. Further, when a compound having the following formula (1) or (2), electrical properties such as sensitivity and residual potential are preferably maintained. 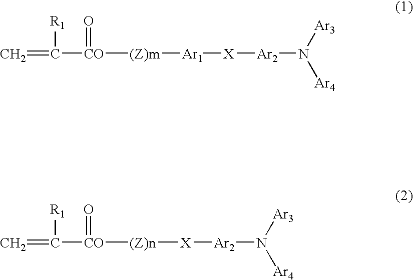
wherein R₁ represents a hydrogen atom, a halogen atom, a substituted or an unsubstituted alkyl group, a substituted or an unsubstituted aralkyl group, a substituted or an unsubstituted aryl group, a cyano group, a nitro group, an alkoxy group, —COOR₂ wherein R₂ represents a hydrogen atom, a halogen atom, a substituted or an unsubstituted alkyl group a substituted or an unsubstituted aralkyl group and a substituted or an unsubstituted aryl group and a halogenated carbonyl group or CONR₃R₄ wherein R₃ and R₄ independently represent a hydrogen atom, a halogen atom, a substituted or an unsubstituted alkyl group, a substituted or an unsubstituted aralkyl group and a substituted or an unsubstituted aryl group; Ar₁ and Ar₂ each, independently, represent a substituted or an unsubstituted arylene group; Ar₃ and Ar₄ each, independently, represent a substituted or an unsubstituted aryl group; X represents a single bond, a substituted or an unsubstituted alkylene group, a substituted or an unsubstituted cycloalkylene group, a substituted or an unsubstituted alkyleneether group, an oxygen atom, a sulfur atom and vinylene group; Z represents a substituted or an unsubstituted alkylene group, a substituted or an unsubstituted alkyleneether group and alkyleneoxycarbonyl group; and m and n represent 0 or an integer of from 1 to 3.

In the formulae (1) and (2) among substituted groups of R₁, the alkyl groups include, but are not limited to, methyl groups, ethyl groups, propyl groups, butyl groups, etc.; the aryl groups include, but are not limited to, phenyl groups, naphtyl groups, etc.; aralkyl groups include, but are not limited to, benzyl groups, phenethyl groups, naphthylmethyl groups etc.; and alkoxy groups include, but are not limited to, methoxy groups, ethoxy groups, propoxy groups, etc.

These may be substituted by alkyl groups such as halogen atoms, nitro groups, cyano groups, methyl groups and ethyl groups; alkoxy groups such as methoxy groups and ethoxy groups; aryloxy groups such as phenoxy groups; aryl groups such as phenyl groups and naphthyl groups; aralkyl groups such as benzyl groups and phenethyl groups.

The substituted group of R₁ is preferably a hydrogen atom and a methyl group.

Ar₃ and Ar₄ each, independently, represent a substituted or an unsubstituted aryl group, and specific examples thereof include, but are not limited to, condensed polycyclic hydrocarbon groups, non-condensed cyclic hydrocarbon groups and heterocyclic groups.

The condensed polycyclic hydrocarbon group is preferably a group having 18 or less carbon atoms forming a ring such as a fentanyl group, a indenyl group, a naphthyl group, an azulenyl group, a heptalenyl group, a biphenylenyl group, an As-indacenyl group, a fluorenyl group, an acenaphthylenyl group, a praadenyl group, an acenaphthenyl group, a phenalenyl group, a phenantolyl group, an anthryl group, a fluoranthenyl group, an acephenantolylenyl group, an aceanthrylenyl group, a triphenylel group, a pyrenyl group, a crycenyl group and a naphthacenyl group.

Specific examples of the non-condensed cyclic hydrocarbon groups and heterocyclic groups include, but are not limited to, monovalent groups of monocyclic hydrocarbon compounds such as benzene, diphenylether, polyethylenediphenylether, diphenylthioether, and diphenylsulfone; monovalent groups of non-condensed hydrocarbon compounds such as biphenyl, polyphenyl, diphenylalkane, diphenylalkene, diphenylalkine, triphenylmethane, distyrylbenzene, 1,1-diphenylcycloalkane, polyphenylalkane and polyphenylalkene; and monovalent groups of ring gathering hydrocarbon compounds such as 9,9-diphenylfluorene.

Specific examples of the heterocyclic groups include, but are not limited to, monovalent groups such as carbazole, dibenzofuran, dibenzothiophene, oxadiazole and thiadiazole.

Specific examples of the substituted or unsubstituted aryl group represented by Ar₃ and Ar₄ include, but are not limited to, the following groups:

(1) a halogen atom, a cyano group and a nitro group;

(2) a straight or a branched-chain alkyl group having 1 to 12, preferably from 1 to 8, and more preferably from 1 to 4 carbon atoms, and these alkyl groups may further include a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkyl groups include, but are not limited to, methyl groups, ethyl groups n-butyl groups, i-propyl groups, t-butyl groups, s-butyl groups, n-propyl groups, trifluoromethyl groups, 2-hydroxyethyl groups, 2-ethoxyethyl groups, 2-cyanoethyl groups, 2-methocyethyl groups, benzyl groups, 4-chlorobenzyl groups, 4-methylbenzyl groups, 4-phenylbenzyl groups, etc.

(3) alkoxy groups (—OR₂) wherein R₂ represents an alkyl group specified in (2). Specific examples thereof include, but are not limited to, methoxy groups, ethoxy groups, n-propoxy groups, I-propoxy groups, t-butoxy groups, s-butoxy groups, I-butoxy groups, 2-hydroxyethoxy groups, benzyloxy groups, trifluoromethoxy groups, etc.

(4) aryloxy groups, and specific examples of the aryl groups include, but are not limited to, phenyl groups and naphthyl groups. These aryl group may include an alkoxy group having 1 to 4 carbon atoms, an alkyl group having 1 to 4 carbon atoms or a halogen atom as a substituent. Specific examples of the aryloxy groups include, but are not limited to, phenoxy groups, 1-naphthyloxy groups, 2-naphthyloxy groups, 4-methoxyphenoxy groups, 4-methylphenoxy groups, etc.

(5) alkyl mercapto groups or aryl mercapto groups such as methylthio groups, ethylthio groups, phenylthio groups and p-methylphenylthio groups. 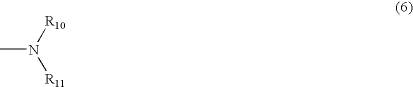
wherein R₁₀ and R₁₁ each, independently, represent a hydrogen atom, an alkyl groups specified in (2) and an aryl group, and specific examples of the aryl groups include, but are not limited to, phenyl groups, biphenyl groups and naphthyl groups and these may include an alkoxy group having 1 to 4 carbon atoms, an alkyl group having 1 to 4 carbon atoms or a halogen atom as a substituent, and R₁₀ and R₁₁ may form a ring together. Specific examples of the groups having this formula include, but are not limited to, amino groups, diethylamino groups, N-methyl-N-phenylamino groups, N,N-diphenylamino groups, N-N-di(tolyl)amino groups, dibenzylamino groups, piperidino groups, morpholino groups, pyrrolidino groups, etc.

(7) a methylenedioxy group, an alkylenedioxy group such as a methylenedithio group or an alkylenedithio group.

(8) a substituted or an unsubstituted styryl group, a substituted or an unsubstituted β-phenylstyryl group, a diphenylaminophenyl group, a ditolylaminophenyl group, etc.

The arylene group represented by Ar₁ and Ar₂ are derivative divalent groups from the aryl groups represented by Ar₃ and Ar₄.

The above-mentioned X represents a single bond, a substituted or an unsubstituted alkylene group, a substituted or an unsubstituted cycloalkylene group, a substituted or an unsubstituted alkylene ether group, an oxygen atom, a sulfur atom and vinylene group.

The substituted or unsubstituted alkylene group is a straight or a branched-chain alkylene group having 1 to 12, preferably from 1 to 8, and more preferably from 1 to 4 carbon atoms, and these alkylene groups may further include a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkylene groups include, but are not limited to, methylene groups, ethylene groups, n-butylene groups, i-propylene groups, t-butylene groups, s-butylene groups, n-propylene groups, trifluoromethylene groups, 2-hydroxyethylene groups, 2 -ethoxyethylene groups, 2-cyanoethylene groups, 2-methocyethylene groups, benzylidene groups, phenylethylene groups, 4-chlorophenylethylene groups, 4-methylphenylethylene groups, 4-biphenylethylene groups, etc.

The substituted or unsubstituted cycloalkylene group is a cyclic alkylene group having 5 to 7 carbon atoms, and these alkylene groups may include a fluorine atom, a hydroxyl group, a cyano group, an alkoxy group having 1 to 4 carbon atoms. Specific examples thereof include, but are not limited to, cyclohexylidine groups, cyclohexylene groups and 3,3-dimethylcyclohexylidine groups, etc.

Specific examples of the substituted or unsubstituted alkyleneether groups include, but are not limited to, ethylene oxy, propylene oxy, ethylene glycol, propylene glycol, diethylene glycol, tetraethylene glycol and tripropylene glycol. The alkylene group of the alkyleneether group may include a substituent such as a hydroxyl group, a methyl group and an ethyl group.

The vinylene group has the following formula: 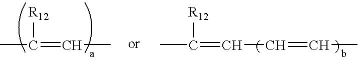
wherein R₁₂ represents a hydrogen atom, an alkyl group (same as those specified in (2)), an aryl group (same as those represented by Ar₃ and Ar₄); a represents 1 or 2; and b represents 1, 2 or 3.

Z represents a substituted or an unsubstituted alkylene group, a substituted or an unsubstituted divalent alkyleneether group and a divalent alkyleneoxycarbonyl group. Specific examples of the substituted or unsubstituted alkylene group include those of X. Specific examples of the substituted or unsubstituted divalent alkyleneether group include those of X. Specific examples of the divalent alkyleneoxycarbonyl group include, but are not limited to, caprolactone-modified groups.

In addition, the monofunctional radical polymerizable compound having a charge transport structure of the present invention is more preferably a compound having the following formula (3): 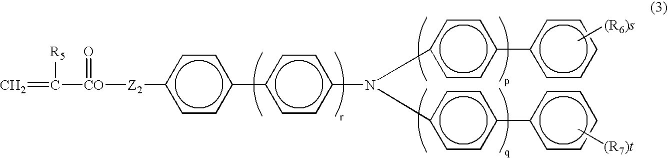
wherein o, p and q each, independently, represent 0 or 1; R₅ represents a hydrogen atom or a methyl group; each of R₆ and R₇ independently represents a substituent besides a hydrogen atom and an alkyl group having 1 to 6 carbon atoms, and may be different from each other when having plural carbon atoms; s and t each, independently, represent 0 or an integer of from 1 to 3; Za represents a single bond, a methylene group, ethylene group,

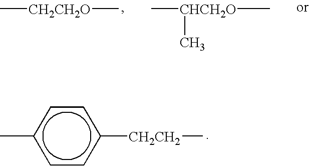

The compound having the formula (3) is preferably a compound having an methyl group or a ethyl group as a substituent of R₆ and R₇.

The monofunctional radical polymerizable compound having a charge transport structure of the formulae (1), (2) and particularly (3) for use in the present invention does not become an end structure because the double bond between the carbons is polymerized and opened to both sides, and is thus incorporated into the chain of the polymer. In a crosslinked polymer polymerized with a radical polymerizable monomer having three or more functional groups, the compound is present in a main chain and in a crosslinked chain between the main chains (the crosslinked chain includes an intermolecular crosslinked chain between a polymer and another polymer and an intramolecular crosslinked chain wherein a portion having a folded main chain and another portion originally from the monomer, which is polymerized with a position apart therefrom in the main chain are polymerized). Even when the compound is present in a main chain or a crosslinked chain, a triarylamine structure suspending from the chain has at least three aryl groups radially located from a nitrogen atom, is not directly bonded with the chain and suspends through a carbonyl group or the like, and is sterically and flexibly fixed although bulky. The triarylamine structures can spatially be located so as to be moderately adjacent to one another in a polymer, and has less structural distortion in a molecule. Therefore, it is supposed that the monofunctional radical polymerizable compound having a charge transport structure in a surface layer of an electrophotographic photoreceptor can have an intramolecular structure wherein blocking of a charge transport route is comparatively prevented.

Further, in the present invention, a specific acrylic acid ester compound having the following formula (4) is preferably used as the monofunctional radical polymerizable compound having a charge transport structure as well:
B₁—Ar₅—CH|CH—Ar₆—B₂ (4)
wherein Ar₅ represents a substituted or an unsubstituted monovalent group or bivalent group formed of an aromatic hydrocarbon skeleton. Specific examples of the monovalent group or bivalent group formed of an aromatic hydrocarbon skeleton include, but are not limited to, monovalent or bivalent groups such as benzene, naphthalene, phenanthrene, biphenyl and 1,2,3,4-tetrahydronaphthalene.

Specific examples of substituents of the aromatic hydrocarbon skeleton include, but are not limited to, an alkyl group having 1 to 12 carbon atoms, an alkoxy group having 1 to -12 carbon atoms, a benzyl group and a halogen atom. The alkyl group and alkoxy group may further have a halogen atom or a phenyl group as a substituent.

Ar₆ represents a monovalent group or a bivalent group formed of an aromatic hydrocarbon skeleton or heterocyclic compound skeleton having one or more tertiary amino group. The aromatic hydrocarbon skeleton having a tertiary amino group has the following formula (A): 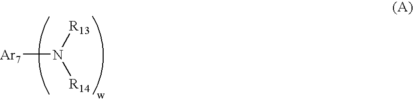
wherein R₁₃ and R₁₄ each, independently, represent an acyl group, a substituted or an unsubstituted alkyl group, a substituted or an unsubstituted aryl group or a substituted or an unsubstituted alkenyl group; Ar₇ represents an aryl group; and h represents an integer of from 1 to 3.

Specific examples of the acyl group include, but are not limited to, an acetyl group, a propionyl group, benzoyl group, etc. Specific examples of the substituted or unsubstituted alkyl group include, but are not limited to, analkyl group having 1 to 12 carbon atoms. Specific examples of the substituted or unsubstituted aryl group include, but are not limited to, a phenyl group, anaphthyl group, a biphenylyl group, aterphenylyl group, pyrenyl group, a fluorenyl group, 9,9-dimethyl-fluorenyl group, azulenyl group, an anthryl group, a triphenylenyl group, a chrysenyl group and groups having the following formulae: 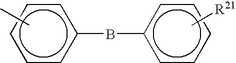
wherein B represents —O—, —S—, —SO—, —SO₂—, —CO— and the following bivalent groups; and R²¹ represents a hydrogen atom, an alkyl group having 1 to 12 carbon atoms, an alkoxy group, a halogen atom, the above-mentioned substituted or unsubstituted aryl groups, an amino group, a nitro group and a cyano group; 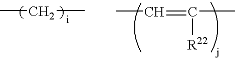
wherein R²² represents a hydrogen atom, an alkyl group having 1 to 12 carbon atoms and the above-mentioned substituted or unsubstituted aryl groups; i represents an integer of from 1 to 12; and j represents an integer of from 1 to 3.

Specific examples of the alkoxy group include, but are not limited to, a methoxy group, an ethoxy group, a n-propoxy group, an i-propoxy group, a n-butoxy group, an i-butoxy group, a s-butoxy group, a t-butoxy group, a 2-hydroxyethoxy group, 2-cyanoethoxy group, a benzyloxy group, a 4-methylbenzyloxy group, a trifluoromethoxy group, etc.

Specific examples of the halogen atom include a fluorine atom, a chlorine atom, a bromine atom and an iodine atom.

Specific examples of the amino group include, but are not limited to, a diphenylamino group, a diethylamino group, a dibenzylamino group, a 4-methylbenzyl group, etc.

Specific examples of the aryl group include, but are not limited to, a phenyl group, a naphthyl group, a biphenylyl group, a terphenylyl group, pyrenyl group, a fluorenyl group, 9,9-dimethyl-fluorenyl group, azulenyl group, an anthryl group, a triphenylenyl group and a chrysenyl group.

Ar₇, R₁₃ and R₁₄ may have an alkyl group having 1 to 12 carbon atoms, an alkoxy group and a halogen atom as a substituent.

Specific examples of the heterocyclic compound skeleton having one or more tertiary amino group include, but are not limited to, heterocyclic compounds having an amine structure such as pyrrole, pyrazole, imidazole, triazole, dioxazole, indole, isoindole, indoline, benzimidazole, benzotriazole, benzoisoxadine, carbazole and phenoxadine. These may have an alkyl group having 1 to 12 carbon atoms, an alkoxy group and a halogen atom as a substituent.

At least B₁ or B₂ is a hydrogen atom, and the other is an acryloyloxy group; a methacryloyloxy group; a vinyl group; an alkyl group having an acryloyloxy group, a methacryloyloxy group or a vinyl group; or an alkoxy group having an acryloyloxy group, a methacryloyloxy group or a vinyl group.

The acrylic acid ester compound having formula (4) is preferably a compound having the following formula (5): 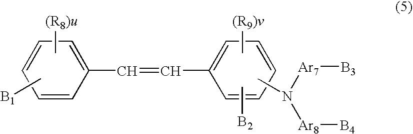
wherein R₈ and R₉ each, independently, represent a substituted or an unsubstituted alkyl group, a substituted or an unsubstituted alkoxy group and a halogen atom; and Ar₇ and Ar₈ each, independently, represent a substituted or an unsubstituted aryl group or arylene group, and a substituted or an unsubstituted benzyl group; B₁ to B₄ are the same groups as B₁ and B₂ in the formula (1), and only one of them is present; u represents 0 or an integer of from 1 to 5; and v represents 0 or an integer of from 1 to 4.

The acrylic acid ester compound has the following characteristics. The acrylic acid ester compound is a tertiary amine compound having a developed stilbene conjugate structure. Such a charge transport compound having a developed conjugate structure very much improves charge injection at an interface of the crosslinked layer. Further, even when fixed between crosslinked bond, intermolecular interactions are difficult to impair and has good charge transportability. Having a highly radical-polymerizable acryloyloxy group or a methacryloyloxy group, the ester acrylic acid ester compound quickly gelates when radical-polymerized and does not have an excessive crosslink distortion. The double-bond of the stilbene conjugate structure partially participates in the polymerization, but less than the acryloyloxy group or methacryloyloxy group, which causes a time difference in the crosslinking reaction and the strain is not maximized. In addition, the double-bond participating in the polymerization can increase the number of crosslinking reactions per molecular weight, resulting in higher crosslink density. Further, the double-bond can control the polymerization with the crosslinking conditions, and can easily form a most suitable crosslinked film. Such a reaction can be performed with the esteracrylate compound of the present invention, but cannot be performed with e.g., an α-phenylstilbene double bond.

The charge transport compound having a radical polymerizable functional group and formula (4), particularly formula (5), can form a highly-cross-linked film maintaining good electrical properties without being cracked which prevents particulate materials such as silica from sticking to a photoreceptor and decreases defective white-spotted images.

The number of radical polymerizable functional groups is preferably less for the uniformity of a crosslinked structure, and preferably more for the abrasion resistance. In the present invention, the number thereof is determined in consideration of the balance.

Specific examples of the radical polymerizable compound having a charge transport structure include, but are not limited to, compounds having the following formulae Nos. 1 to 185:

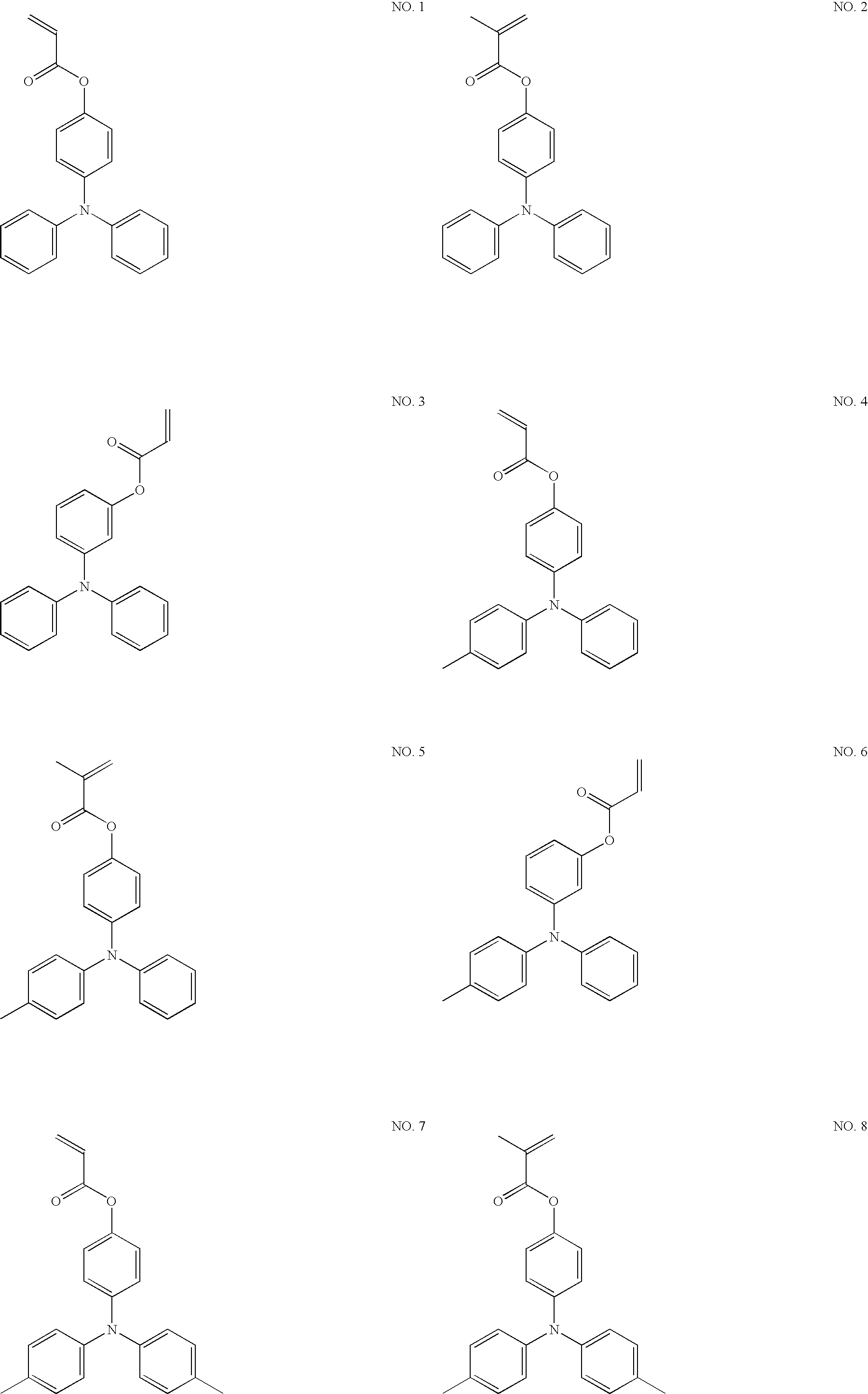

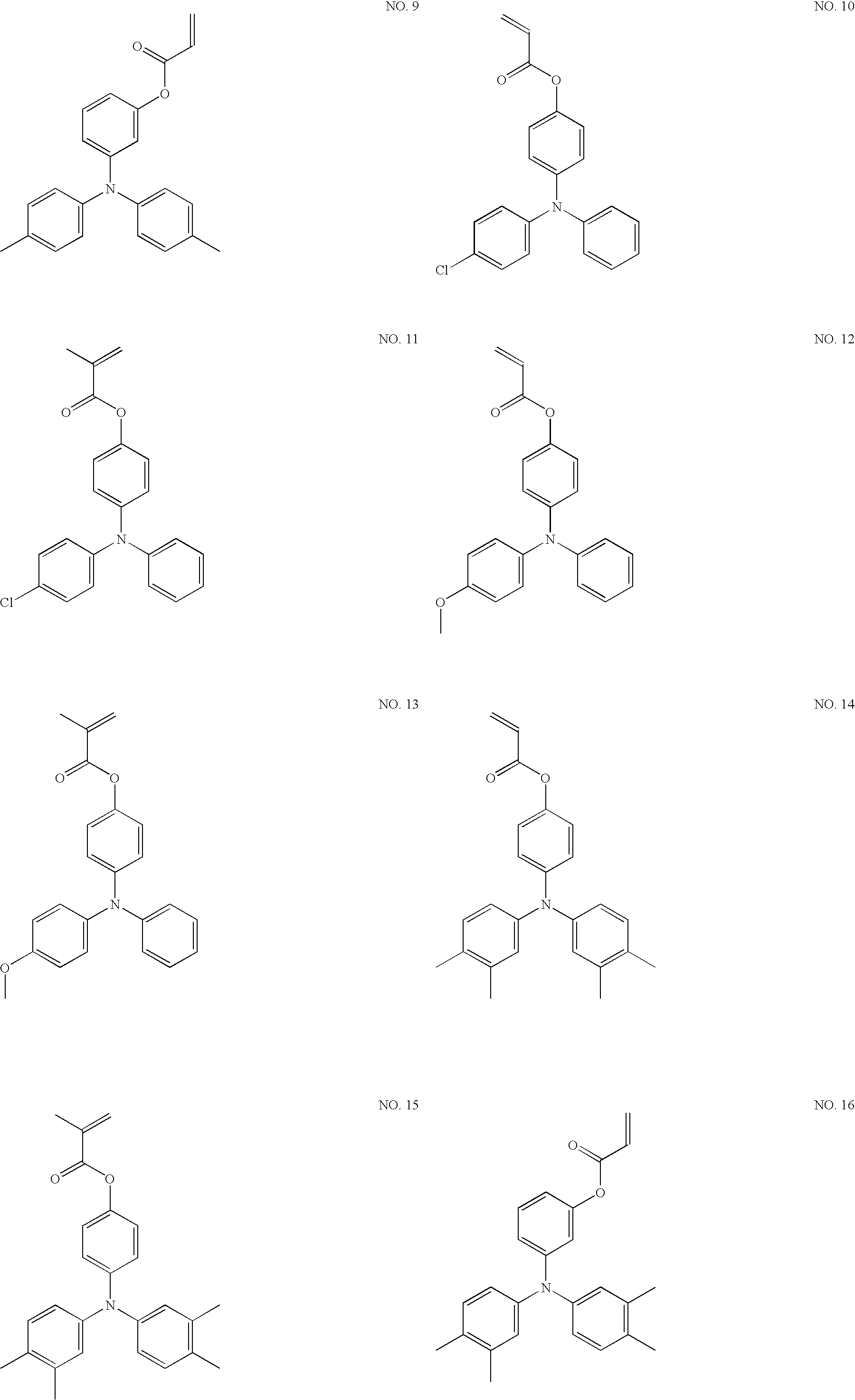

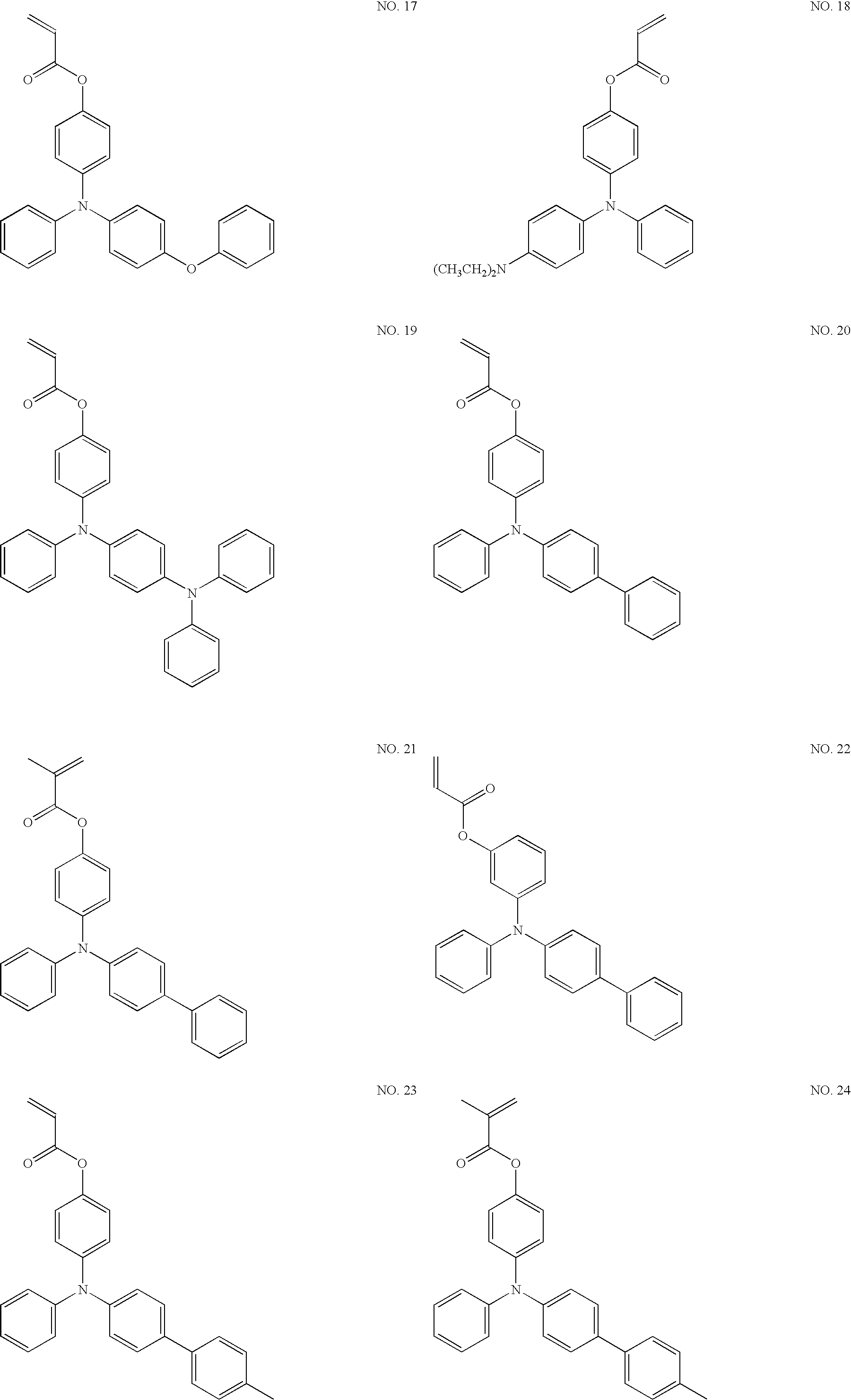

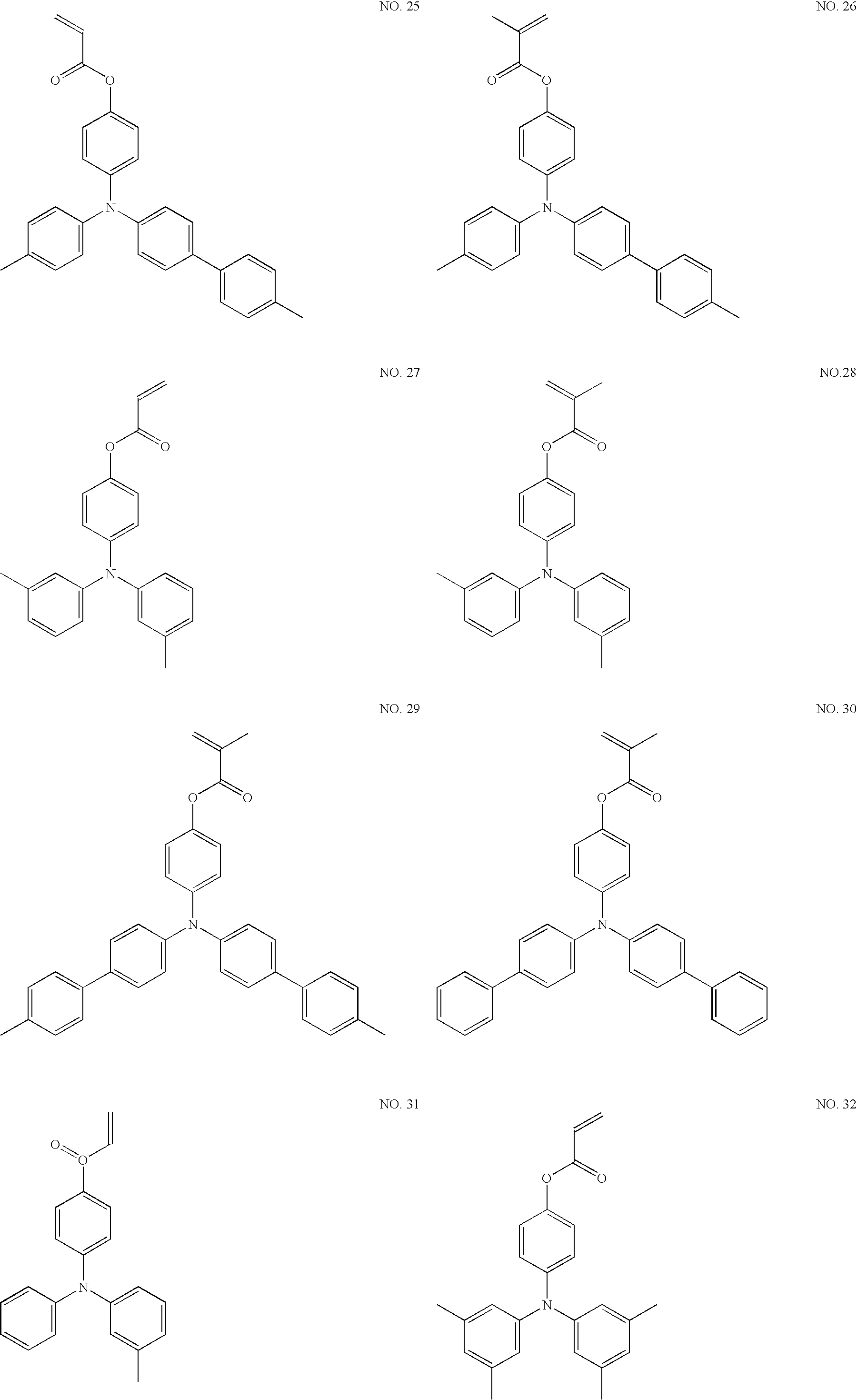

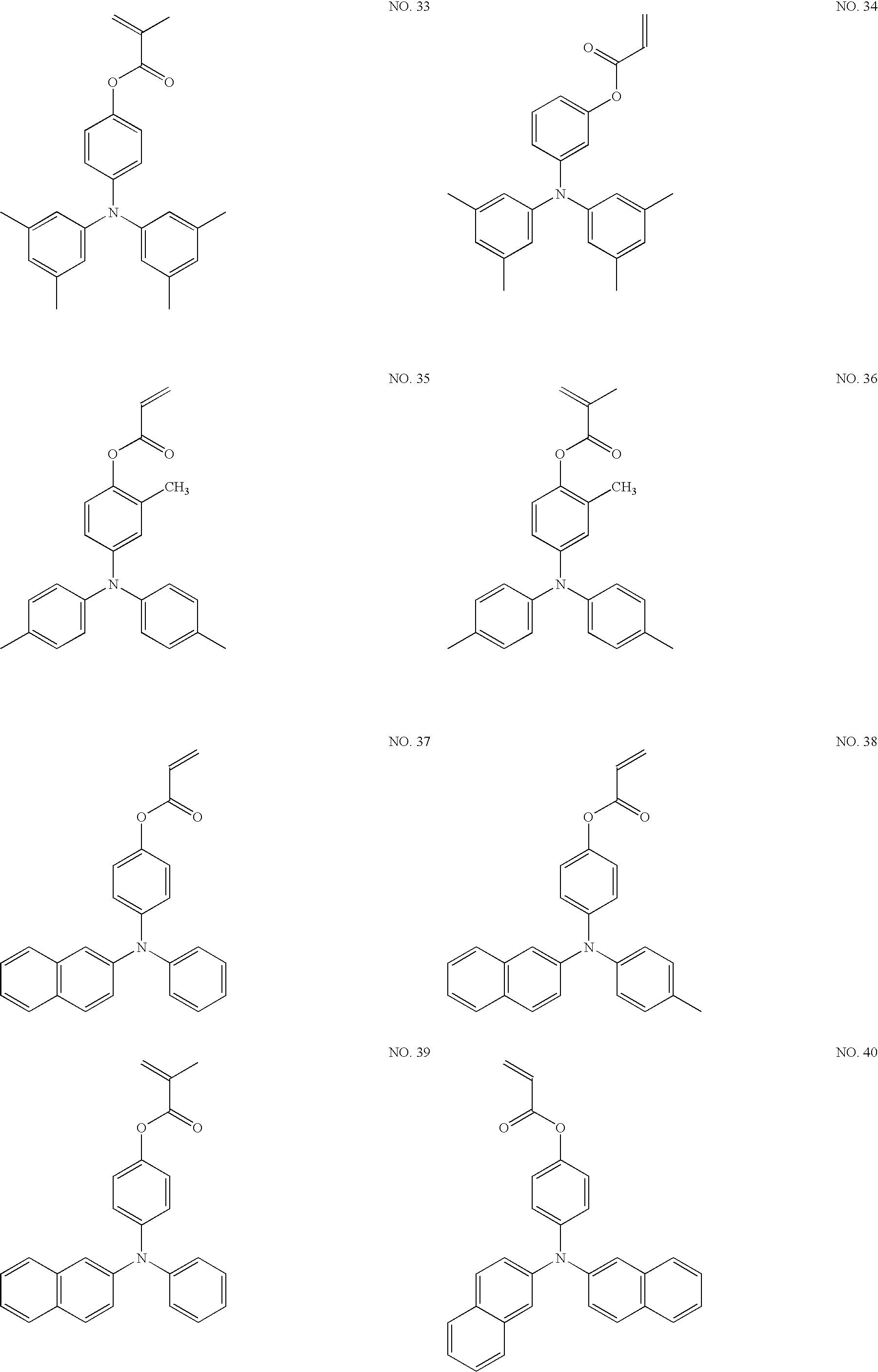

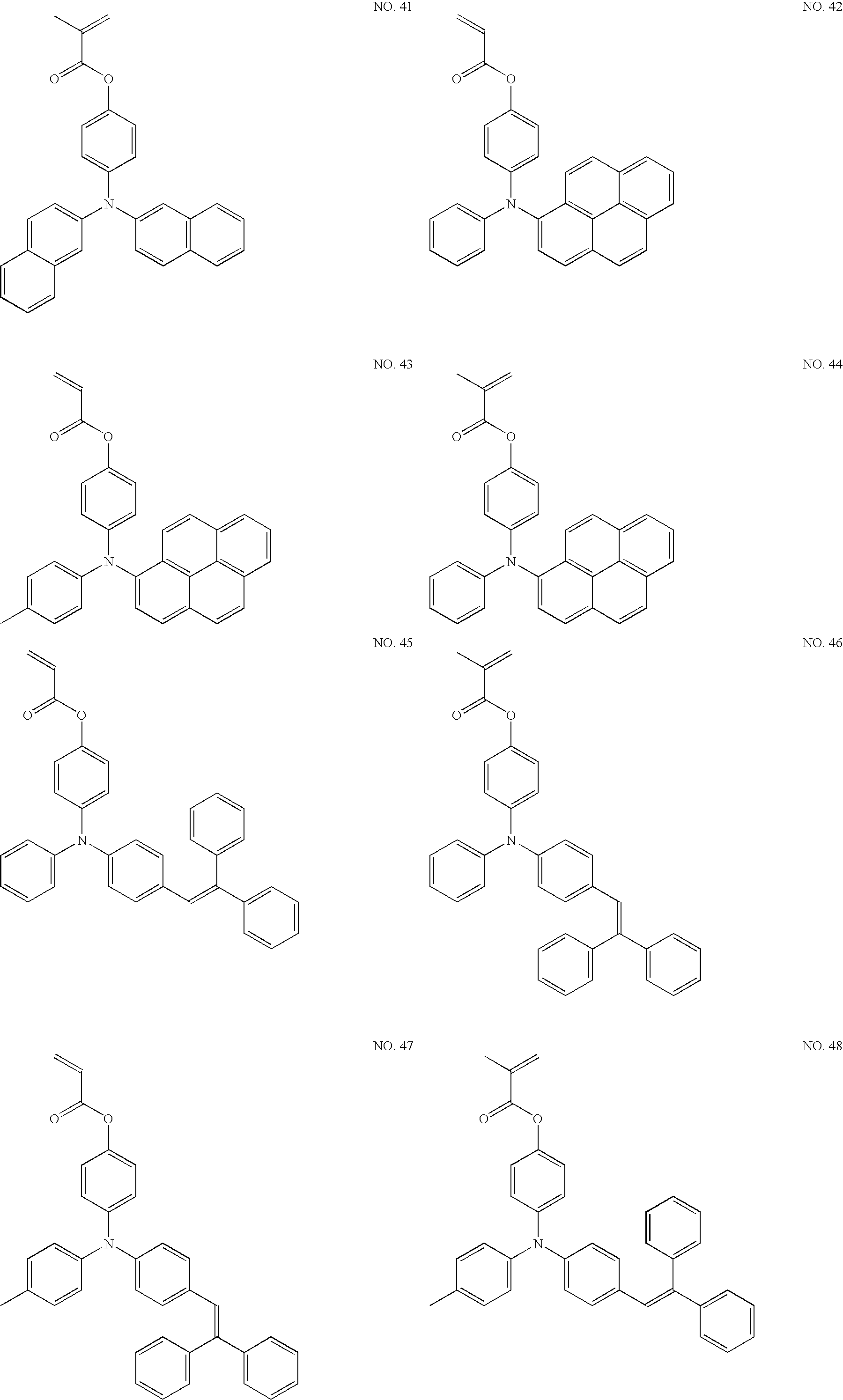

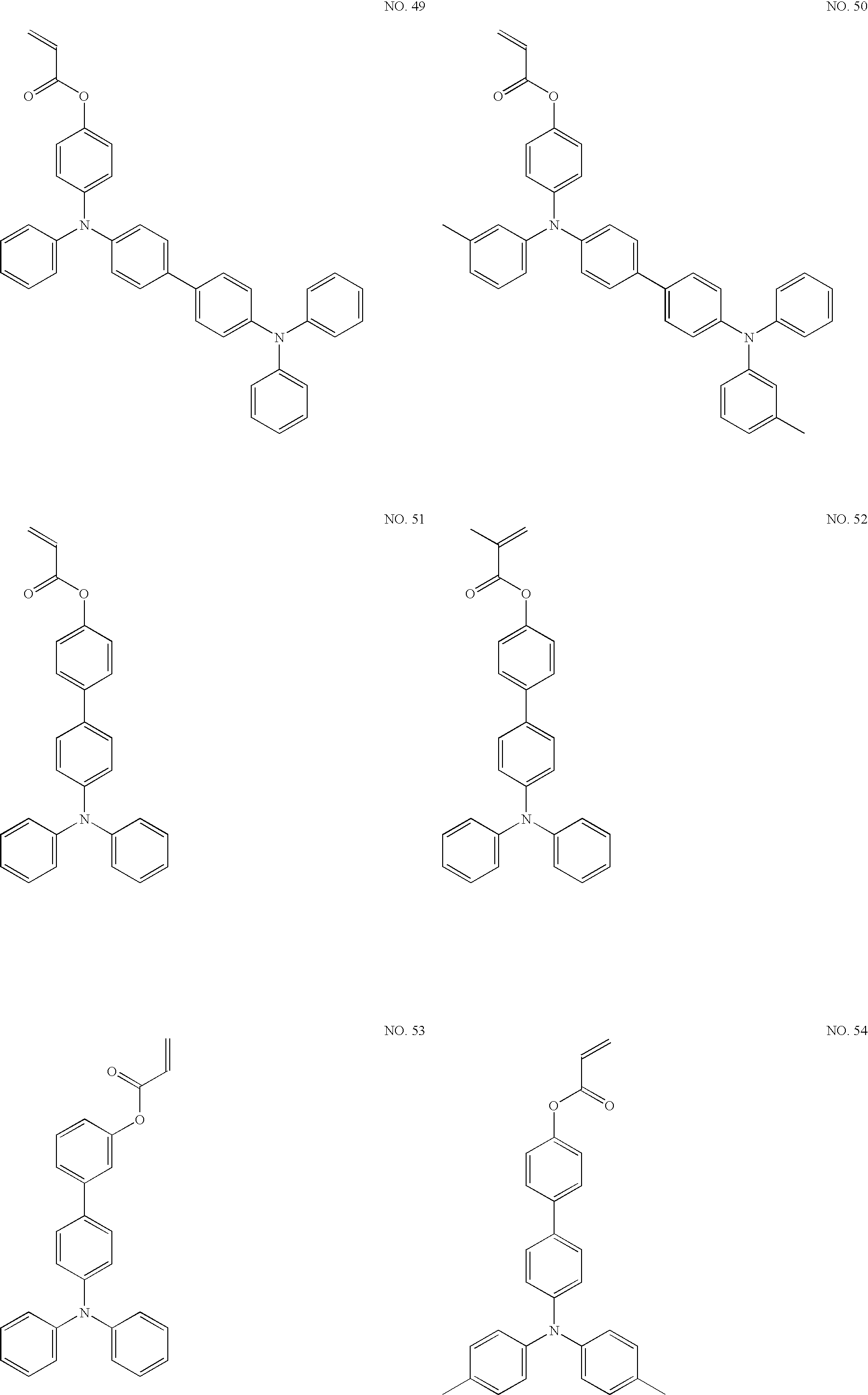

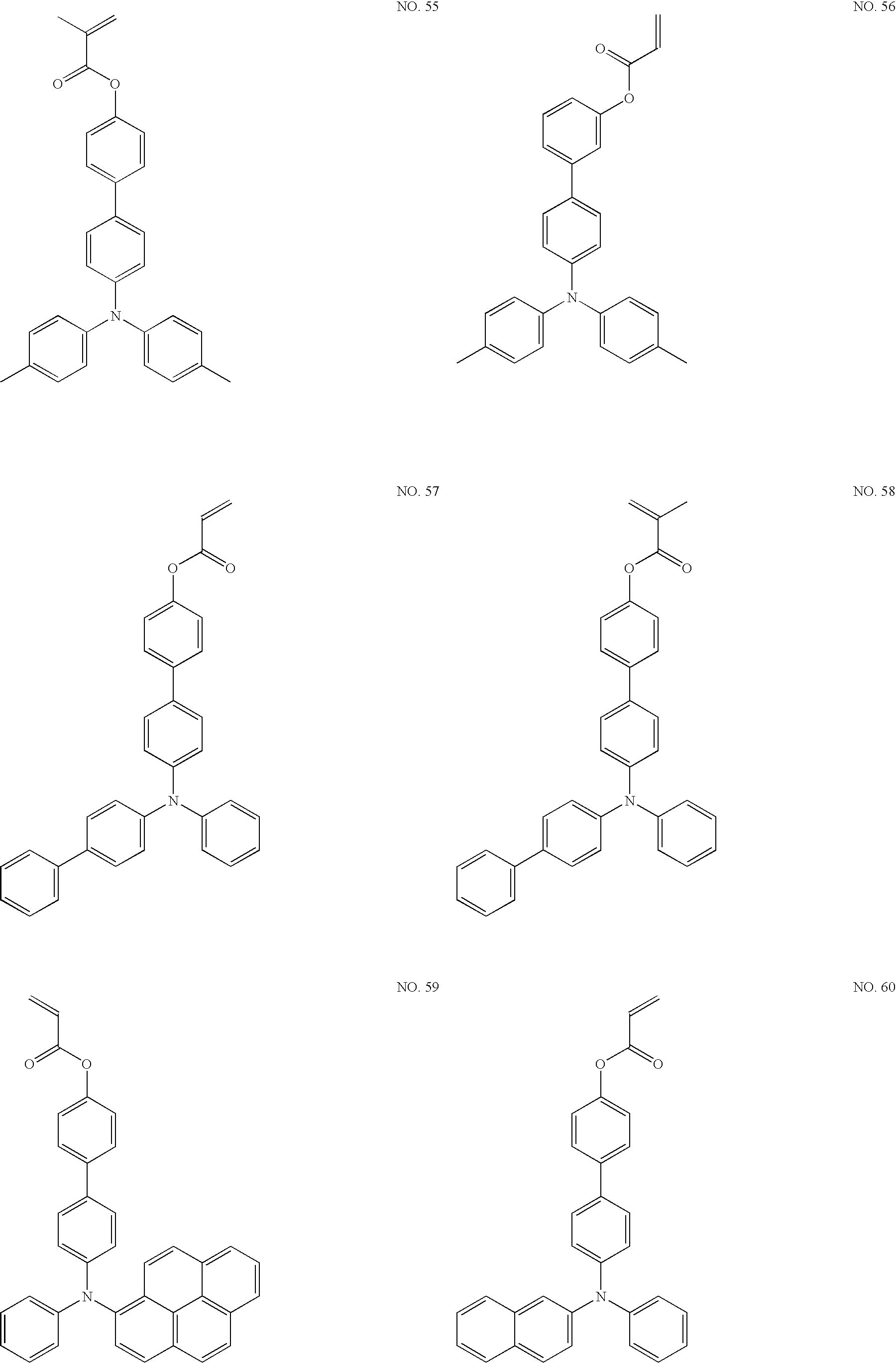

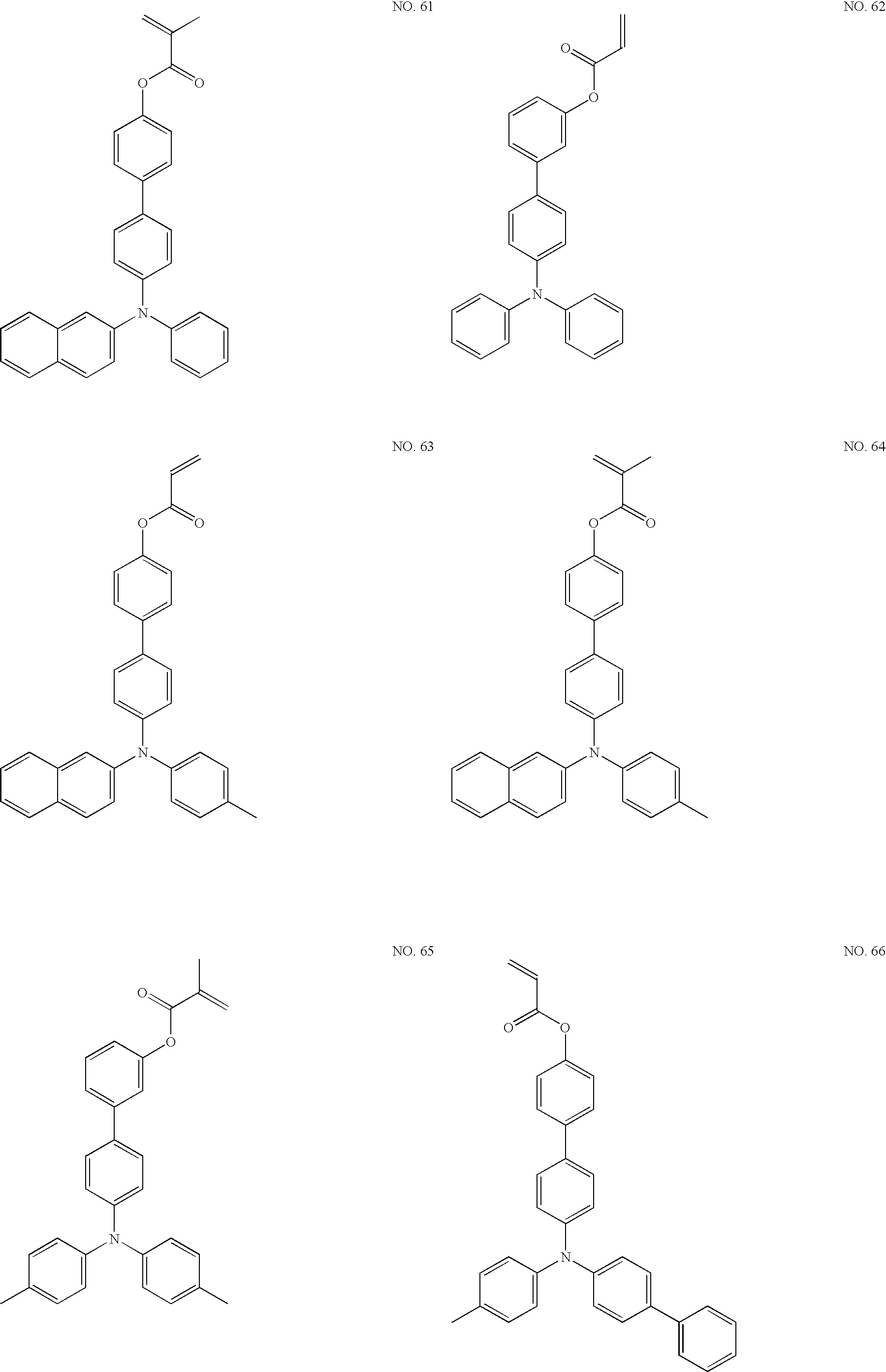

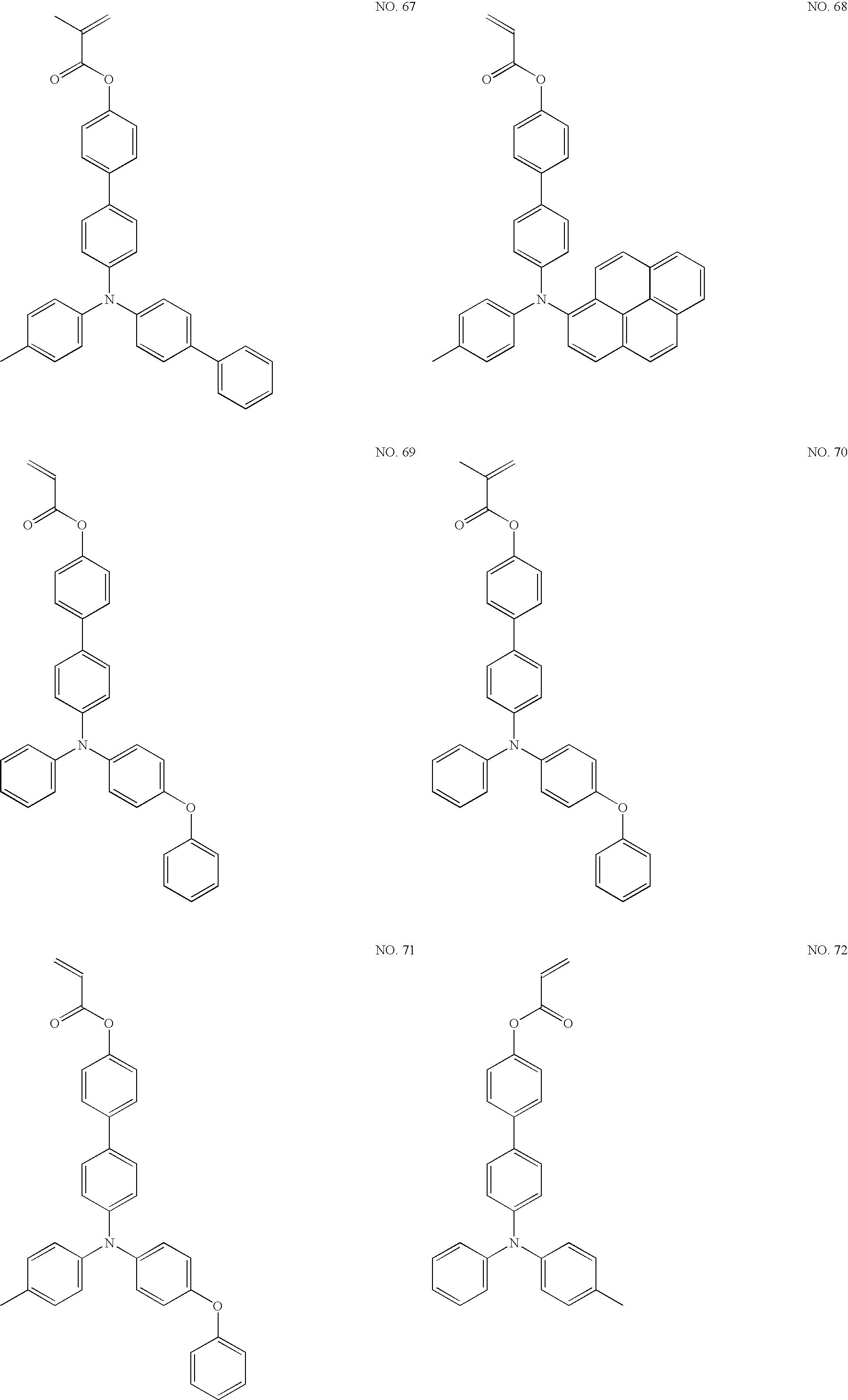

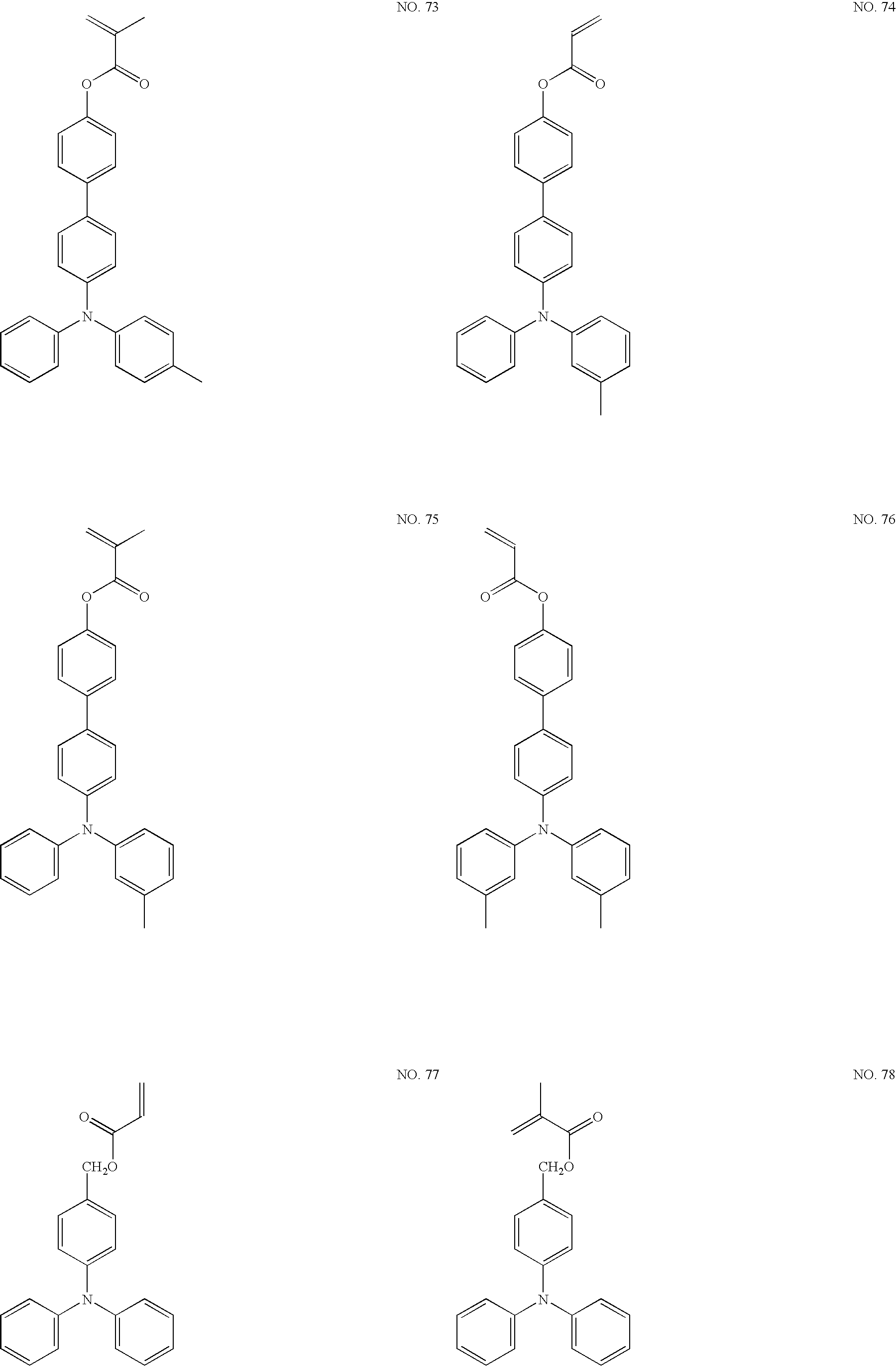

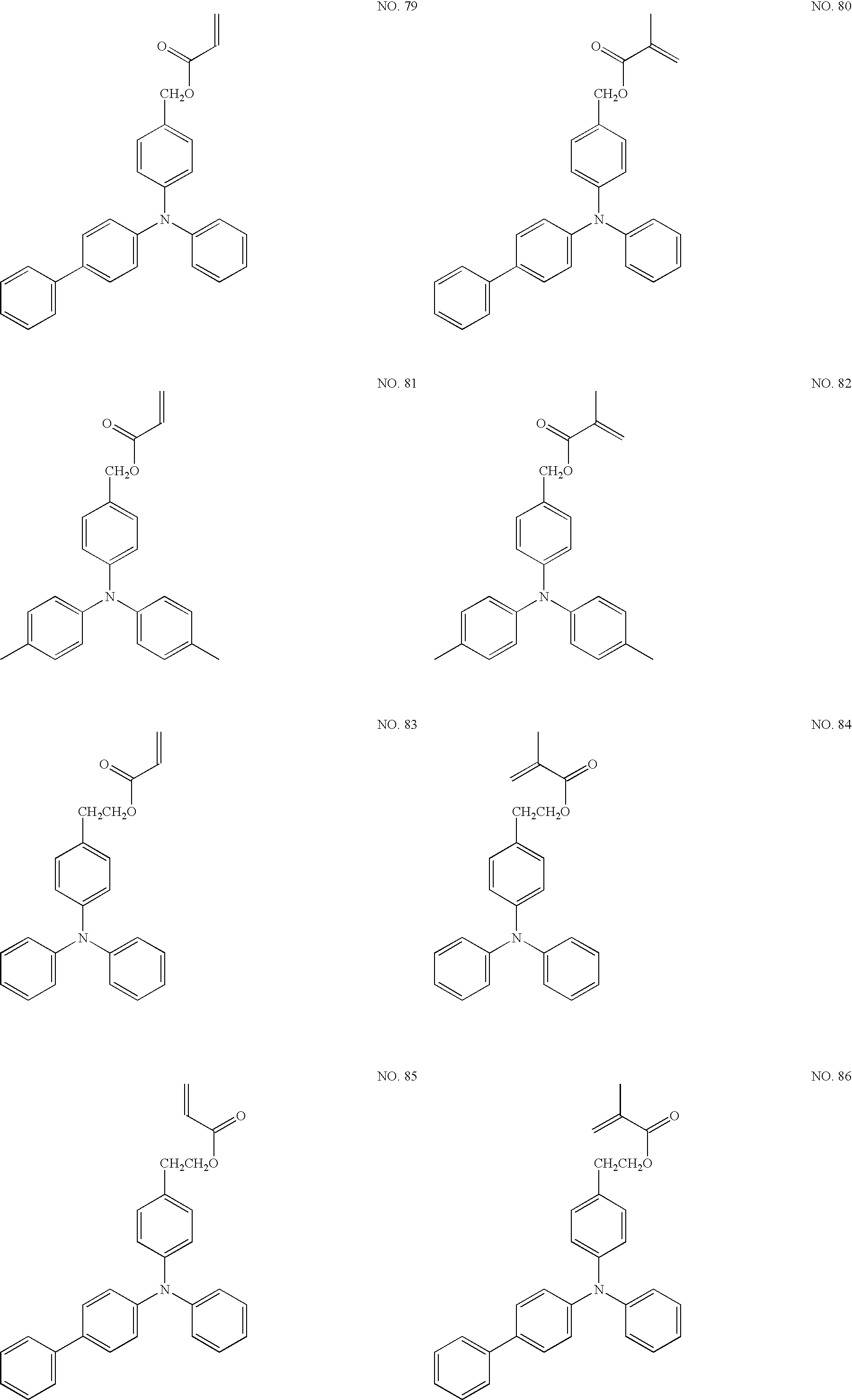

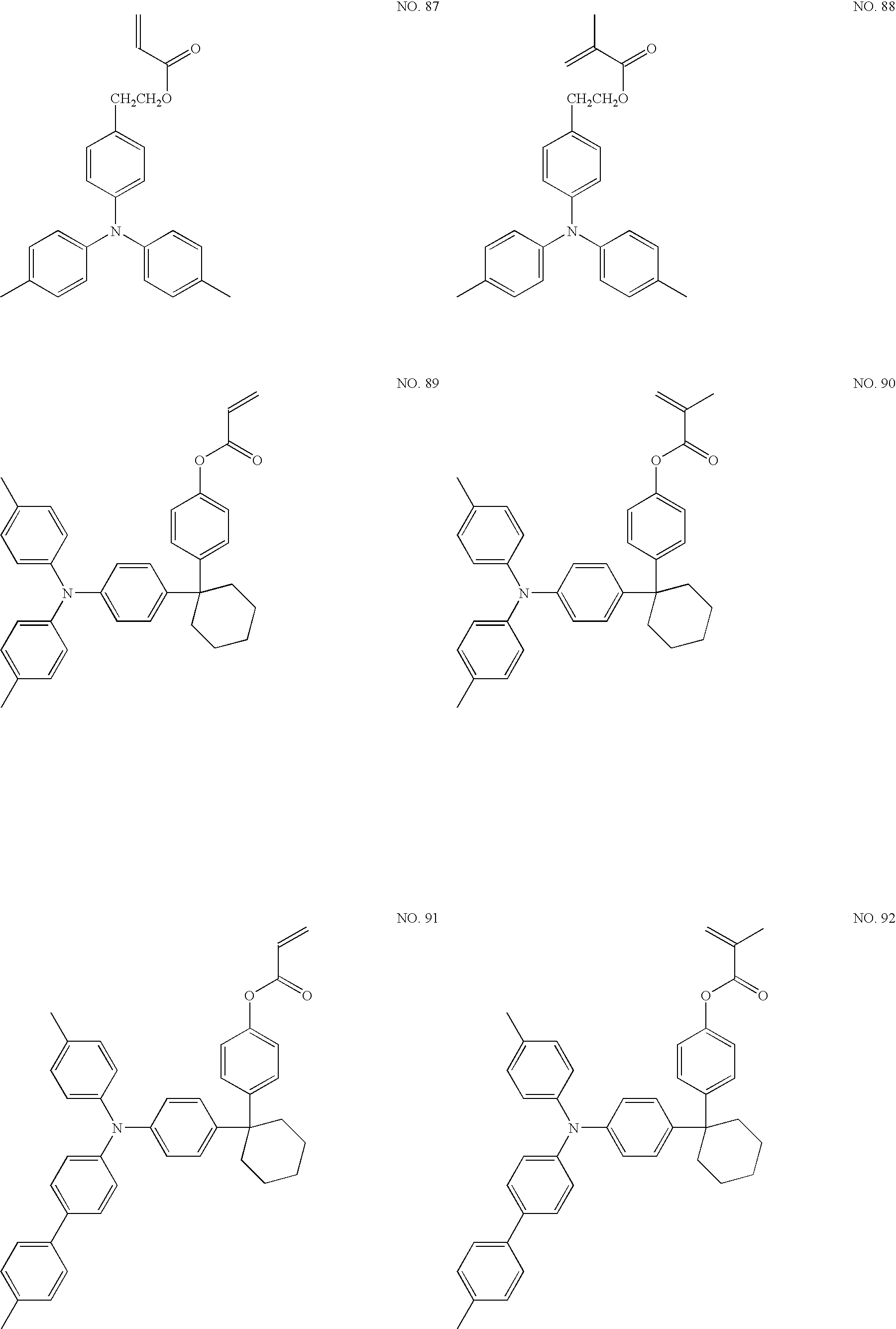

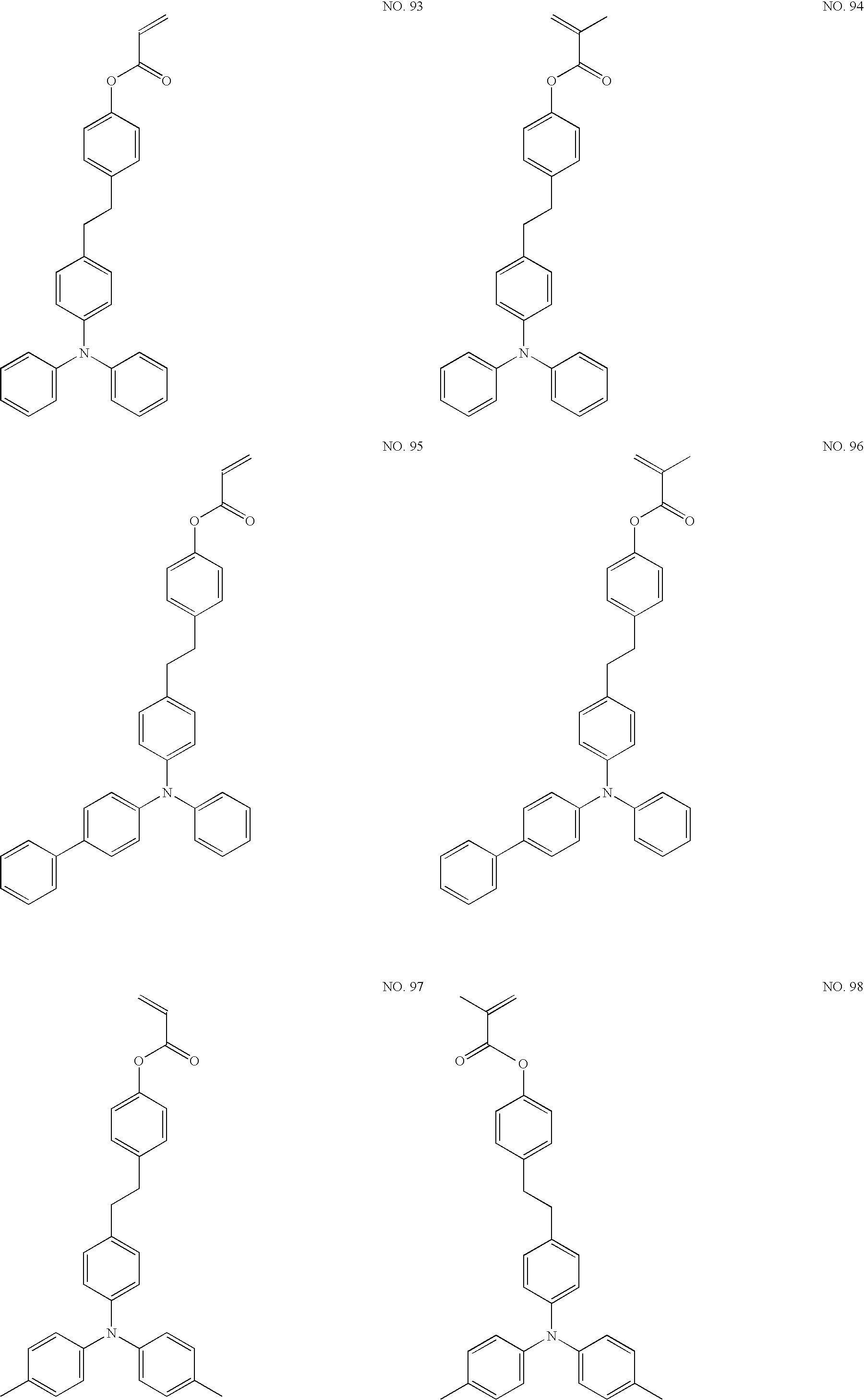

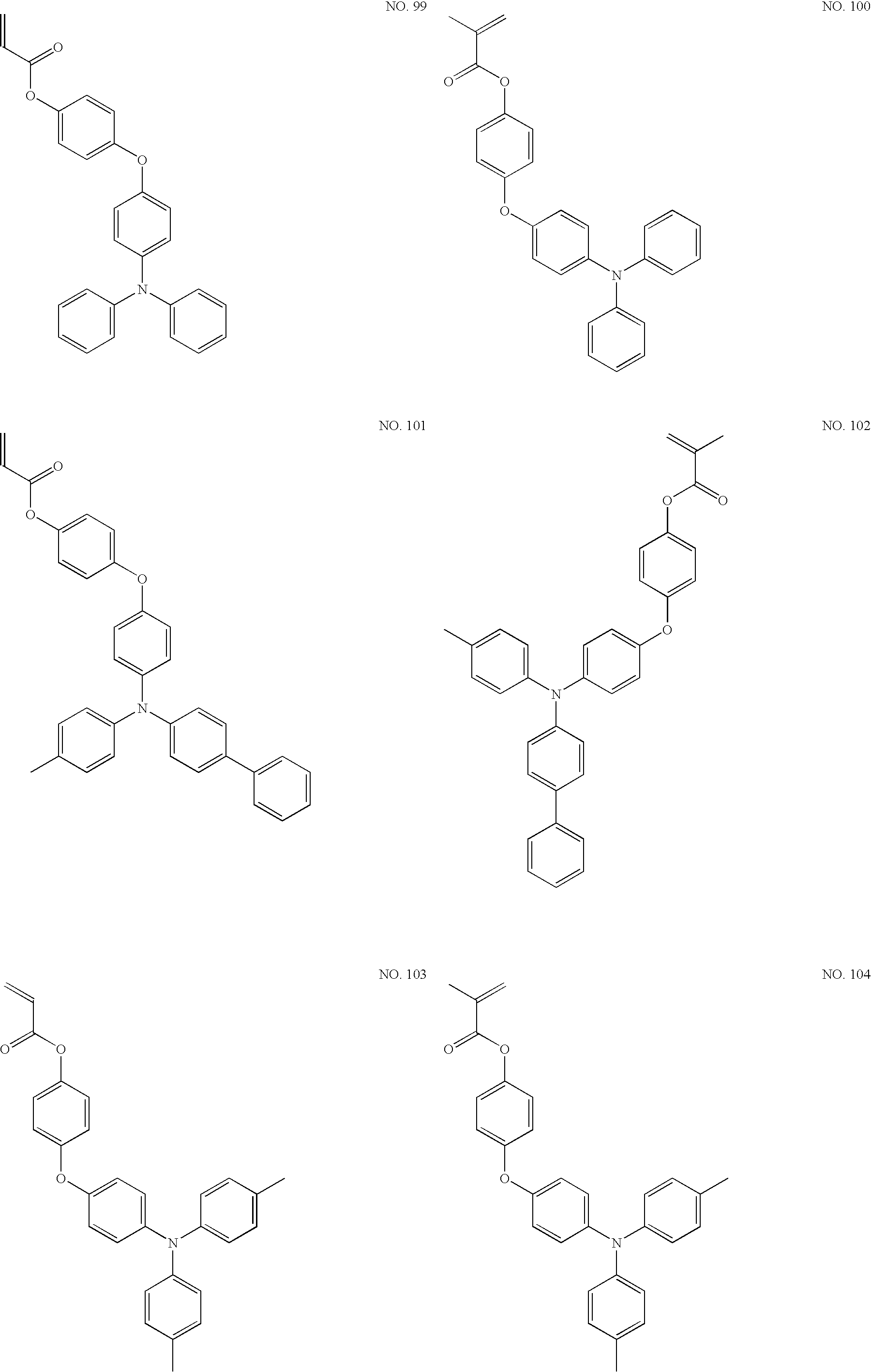

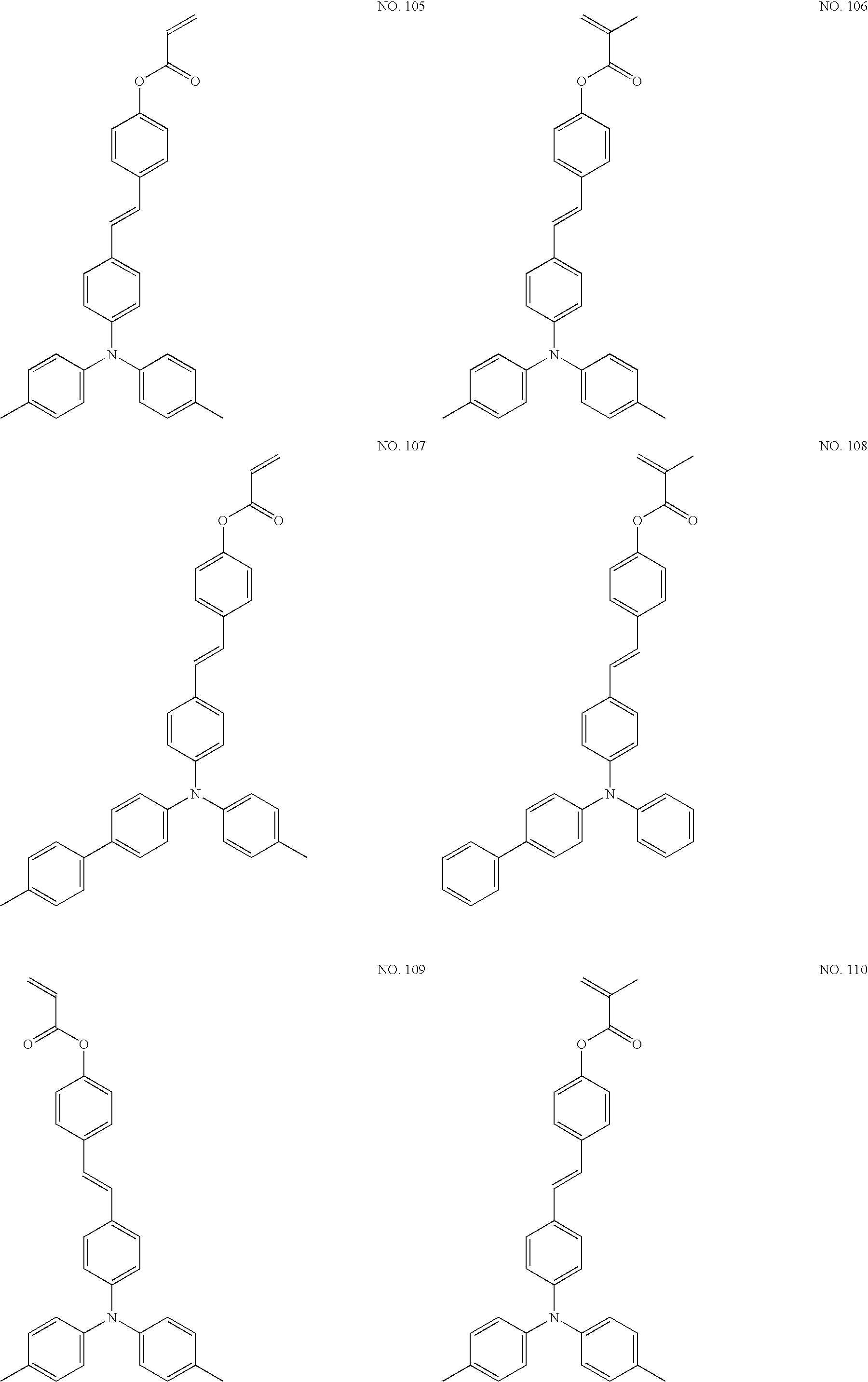

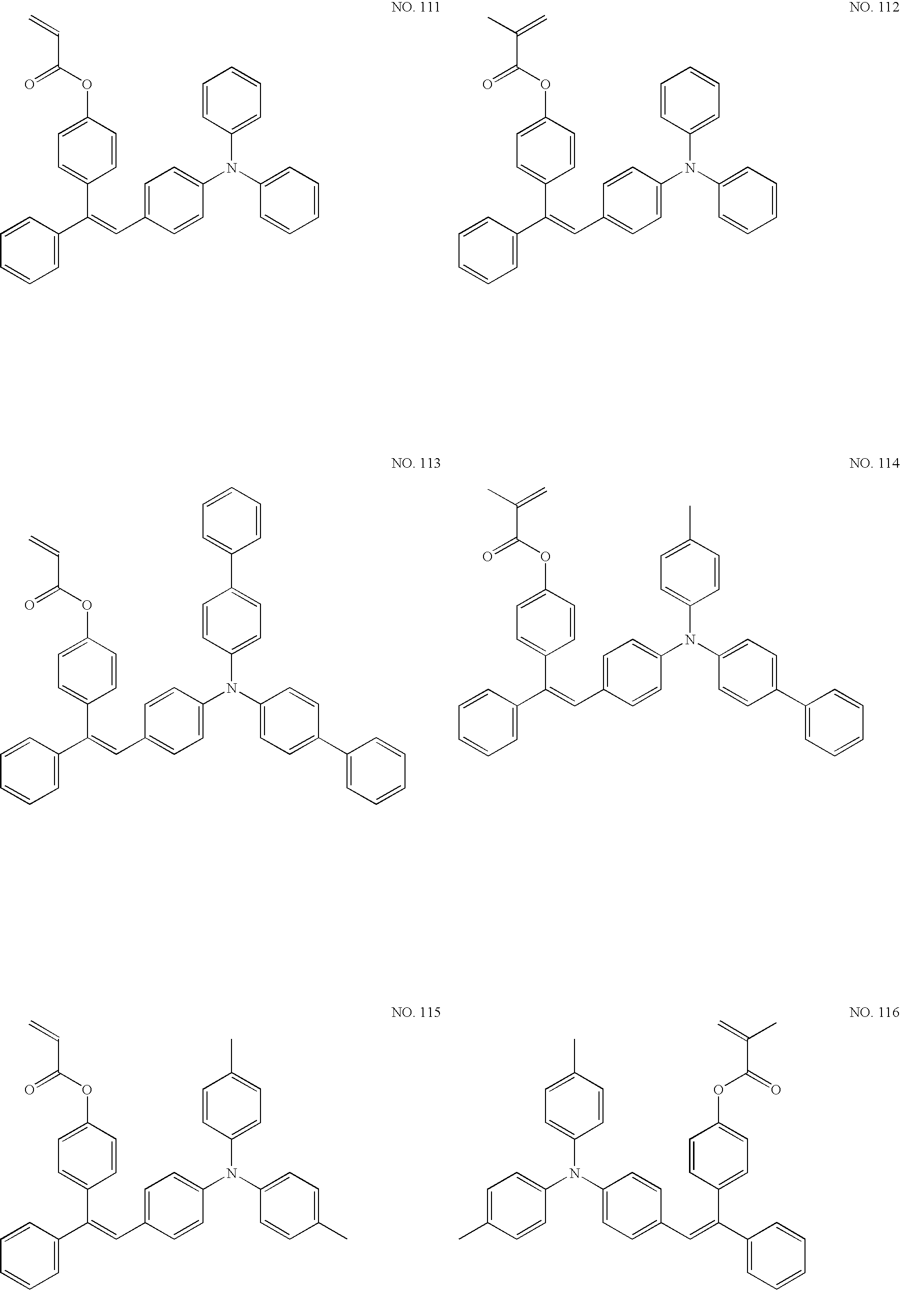

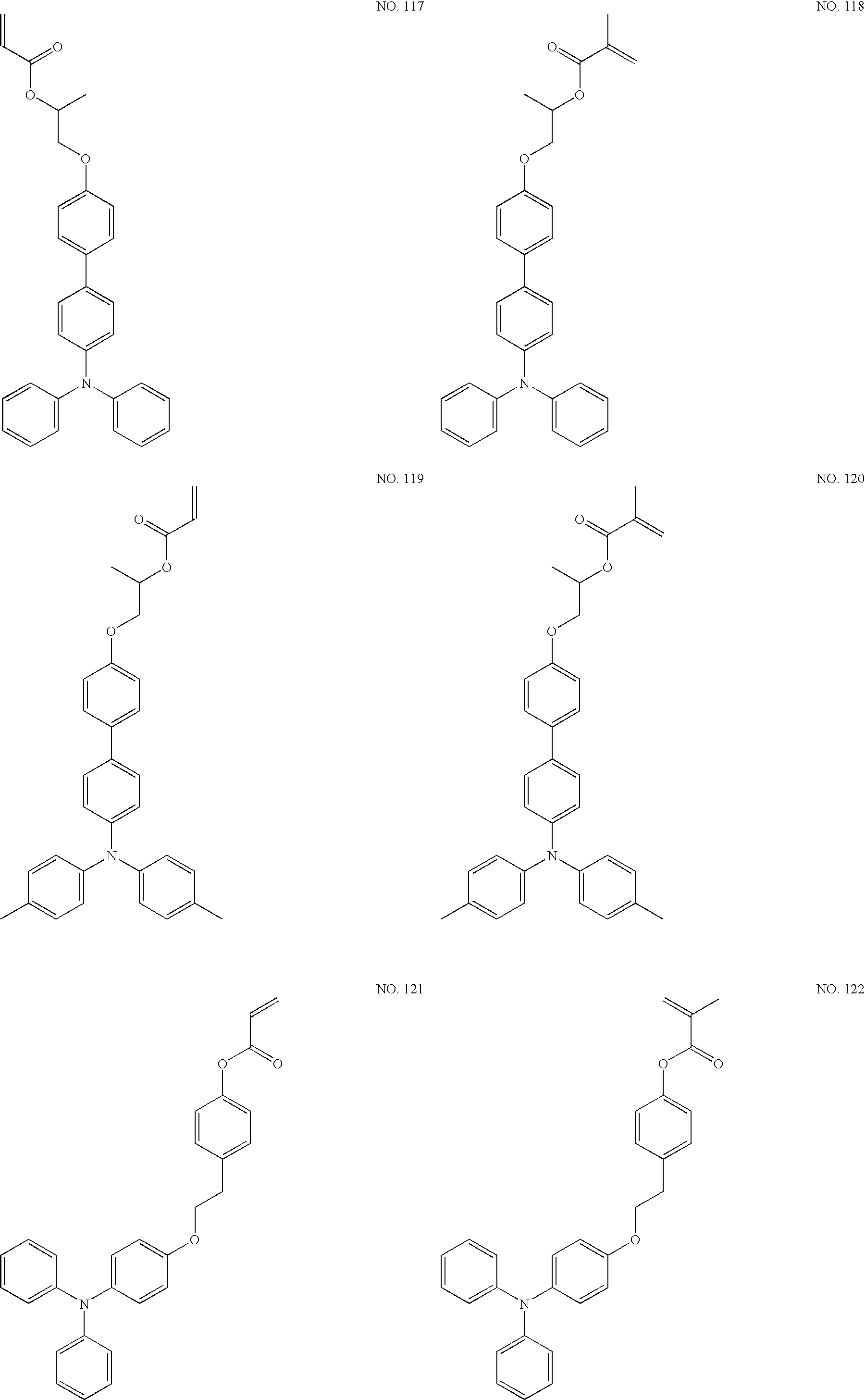

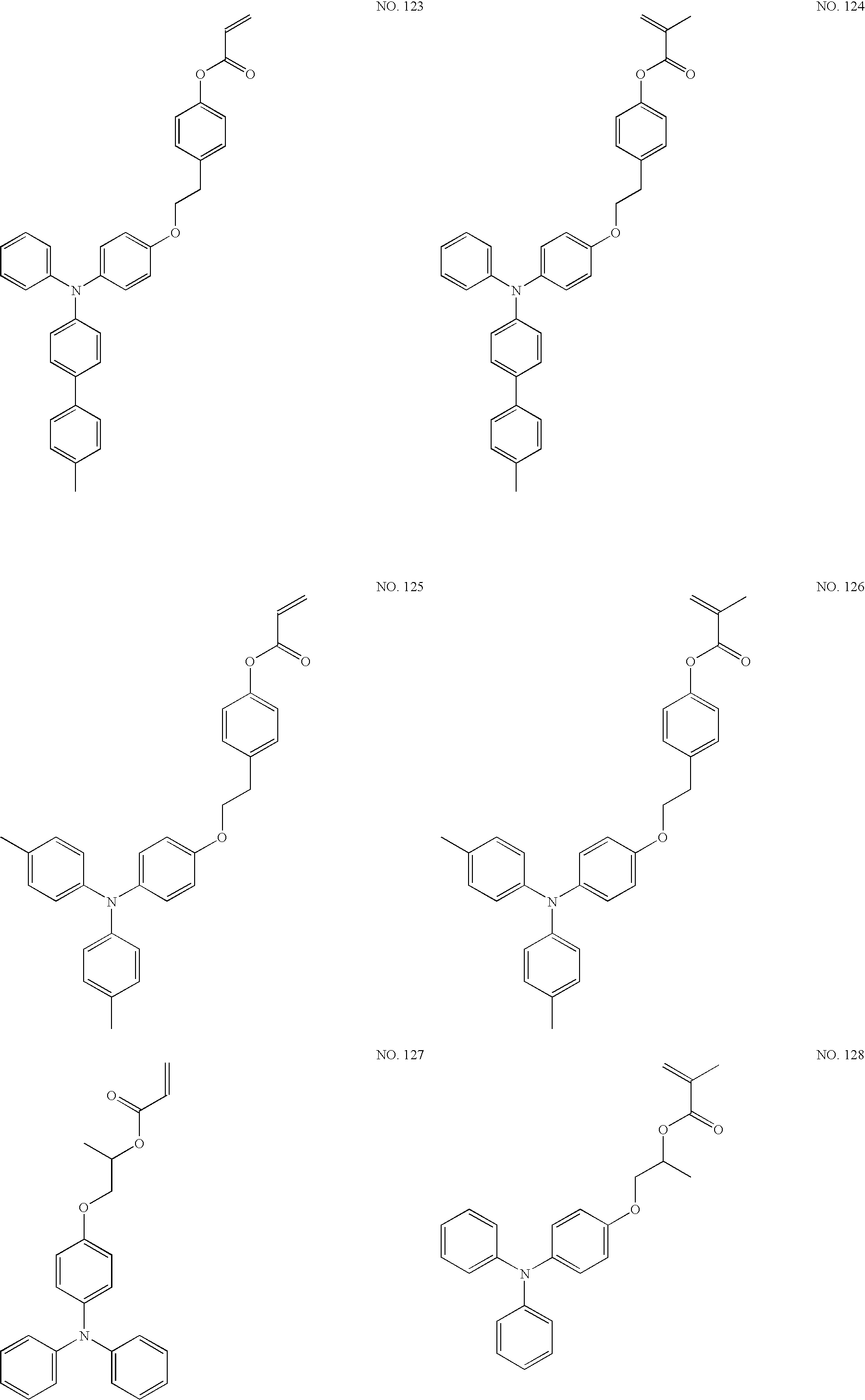

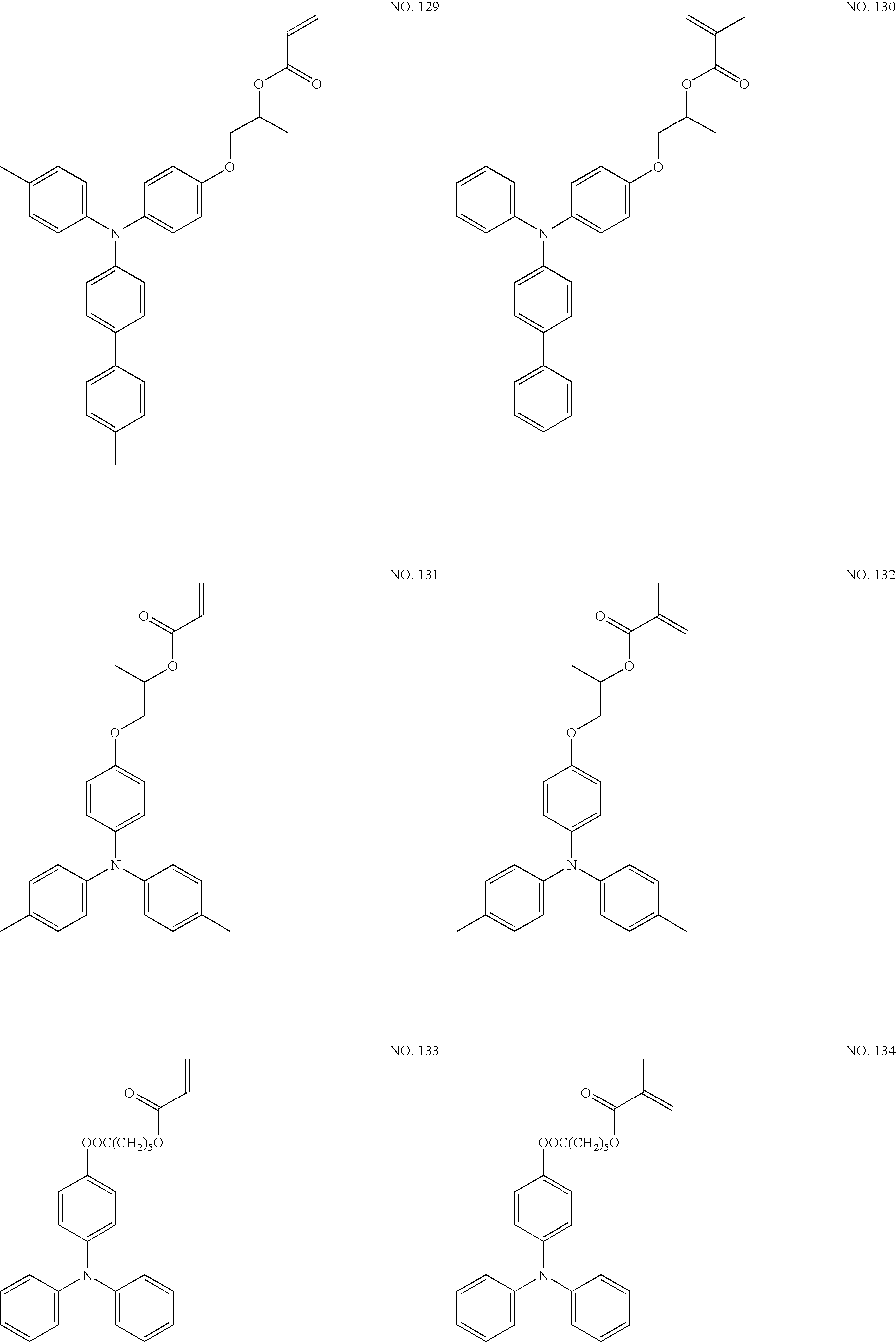

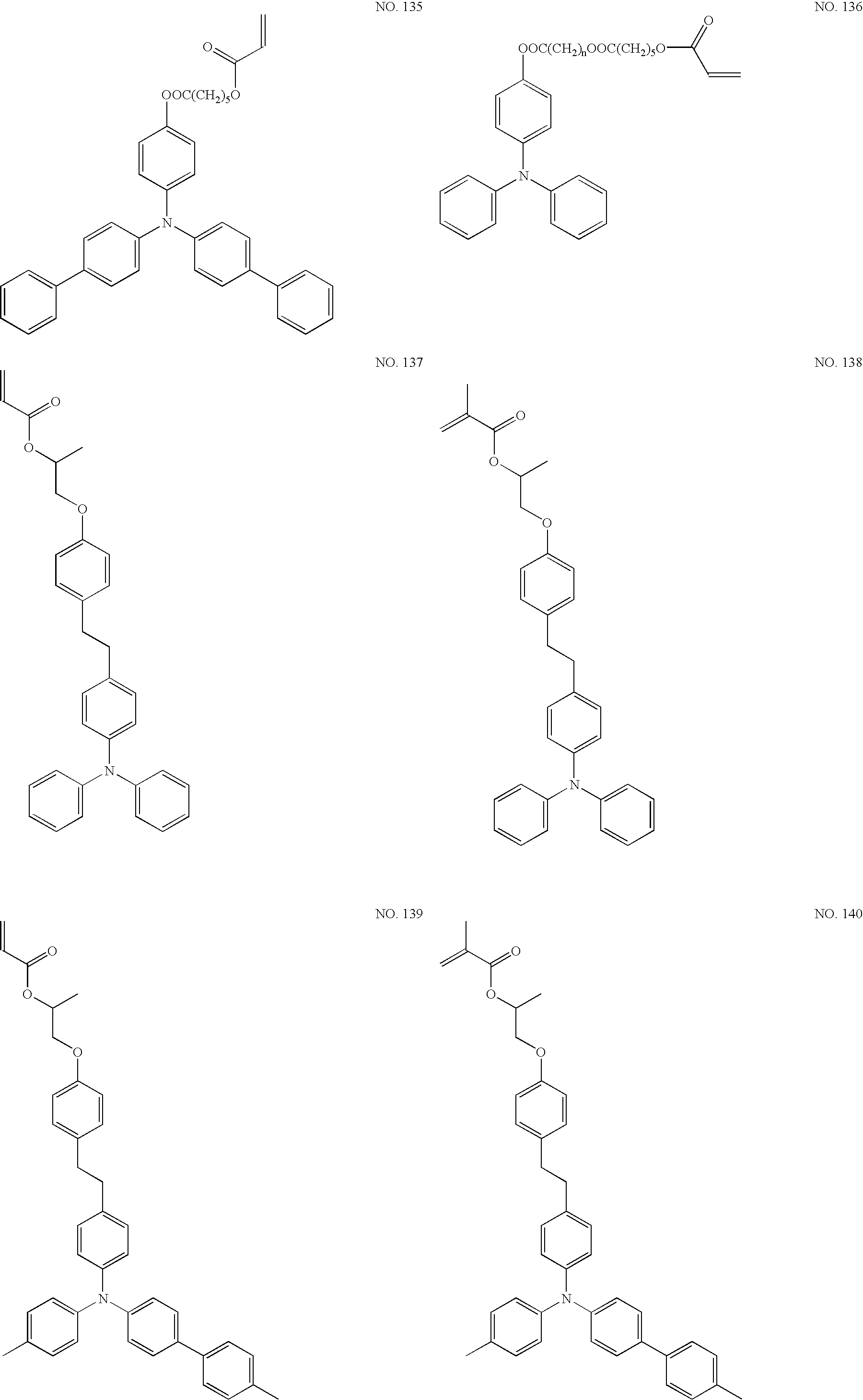

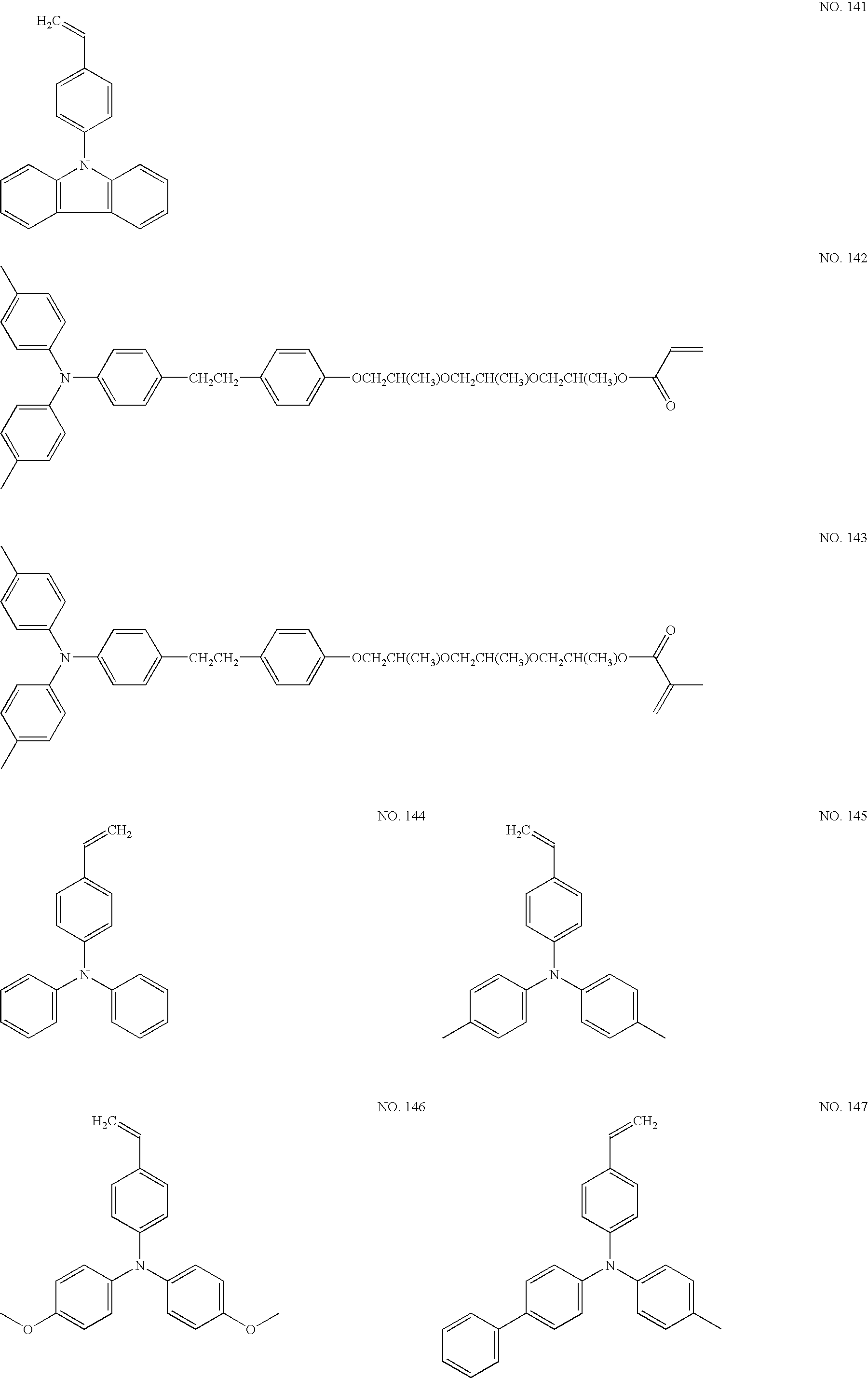

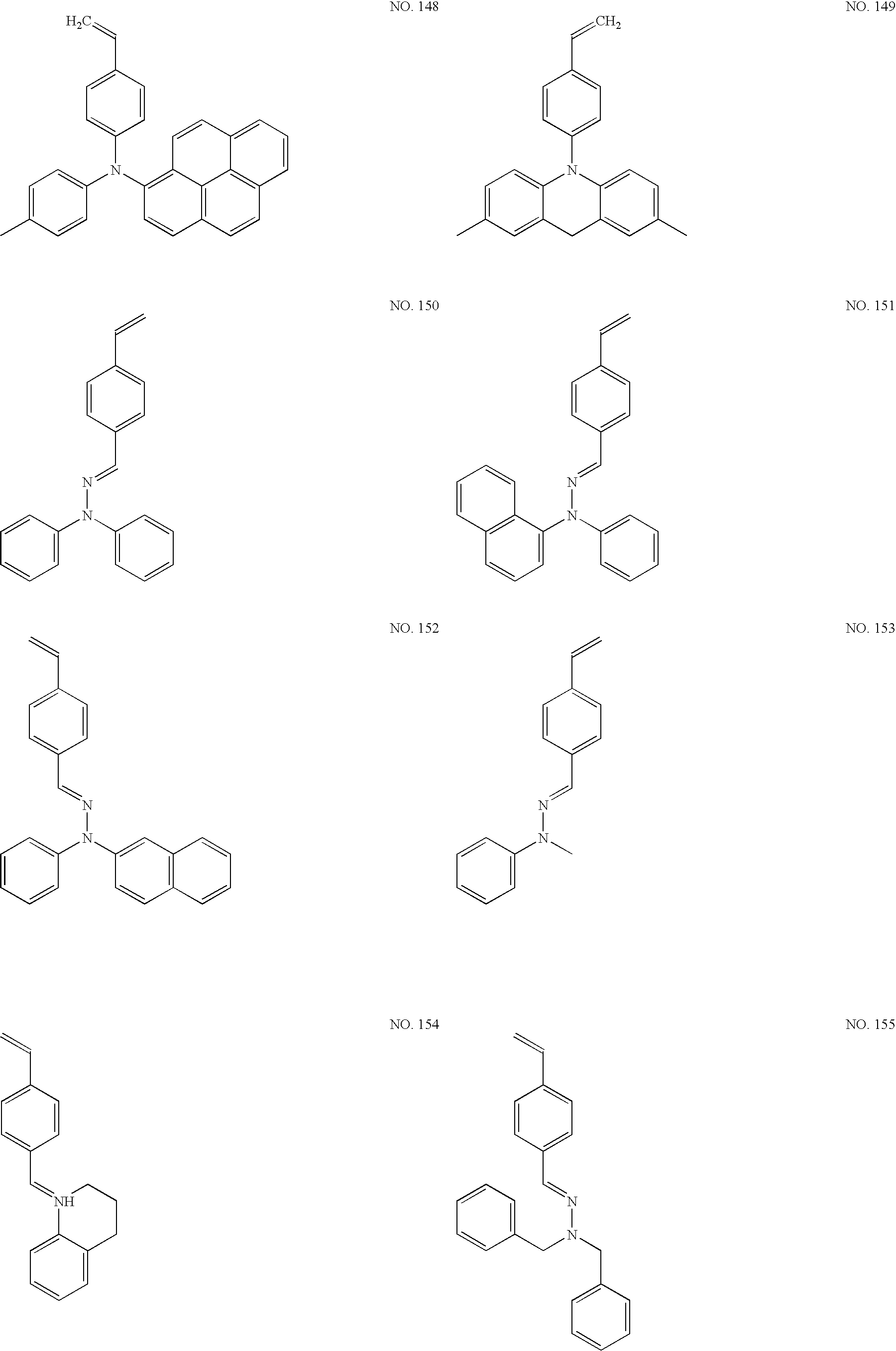

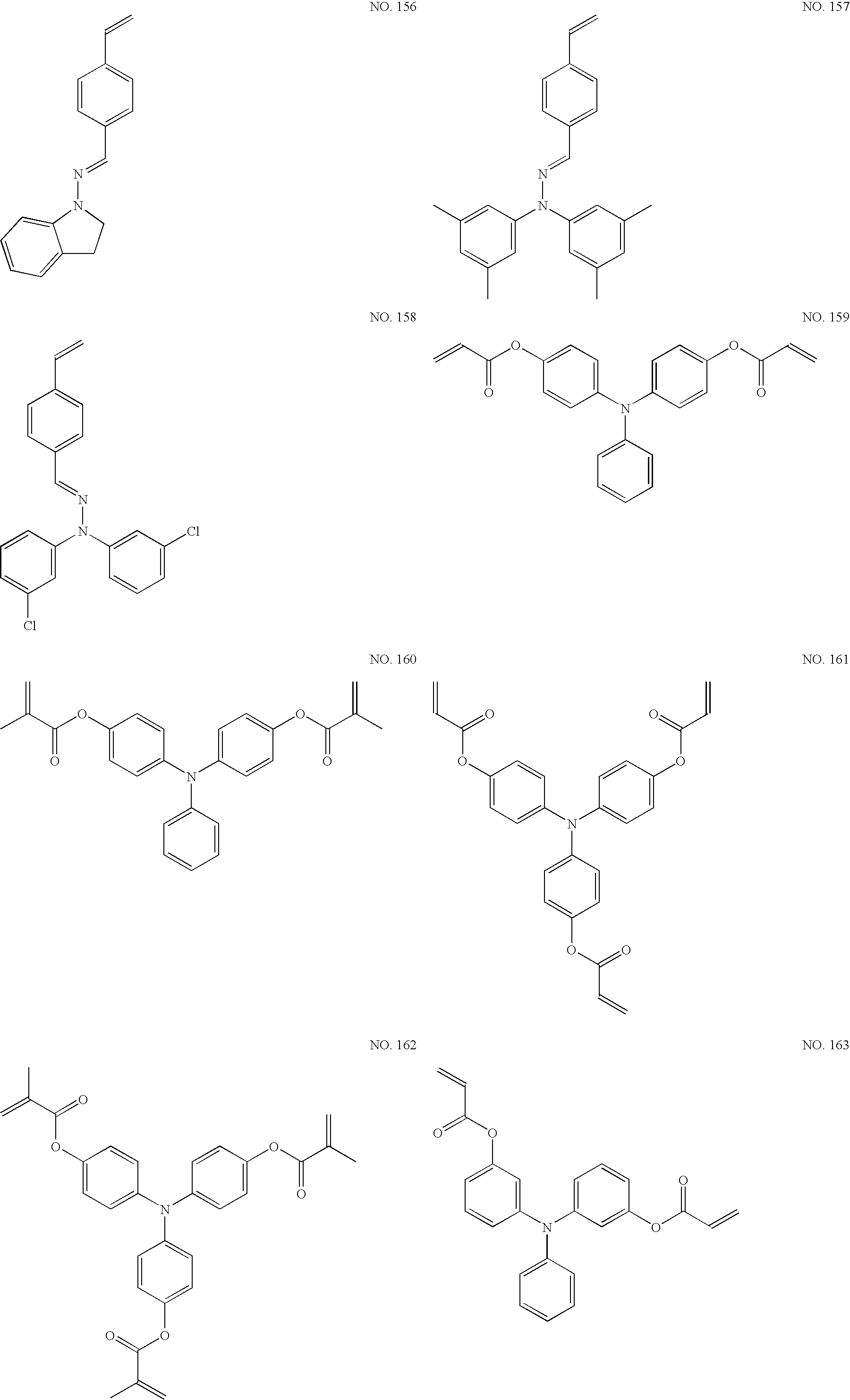

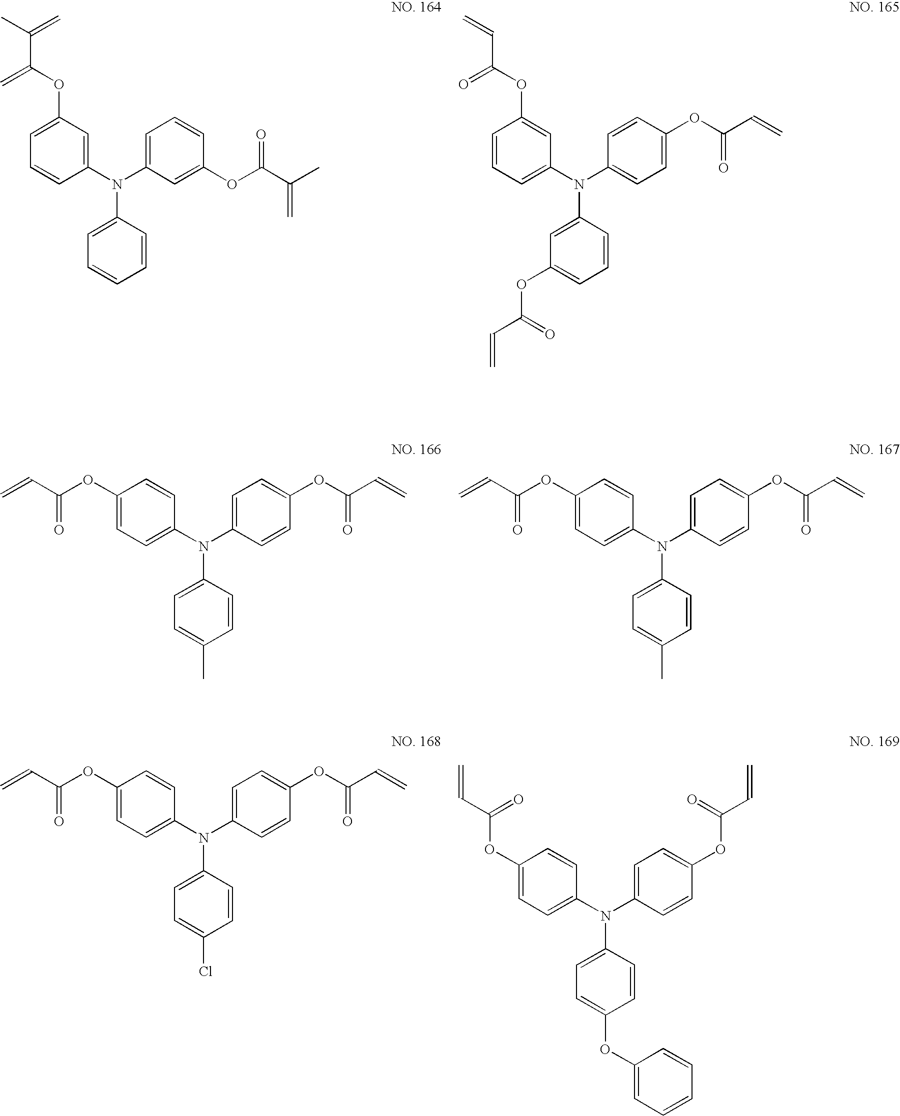

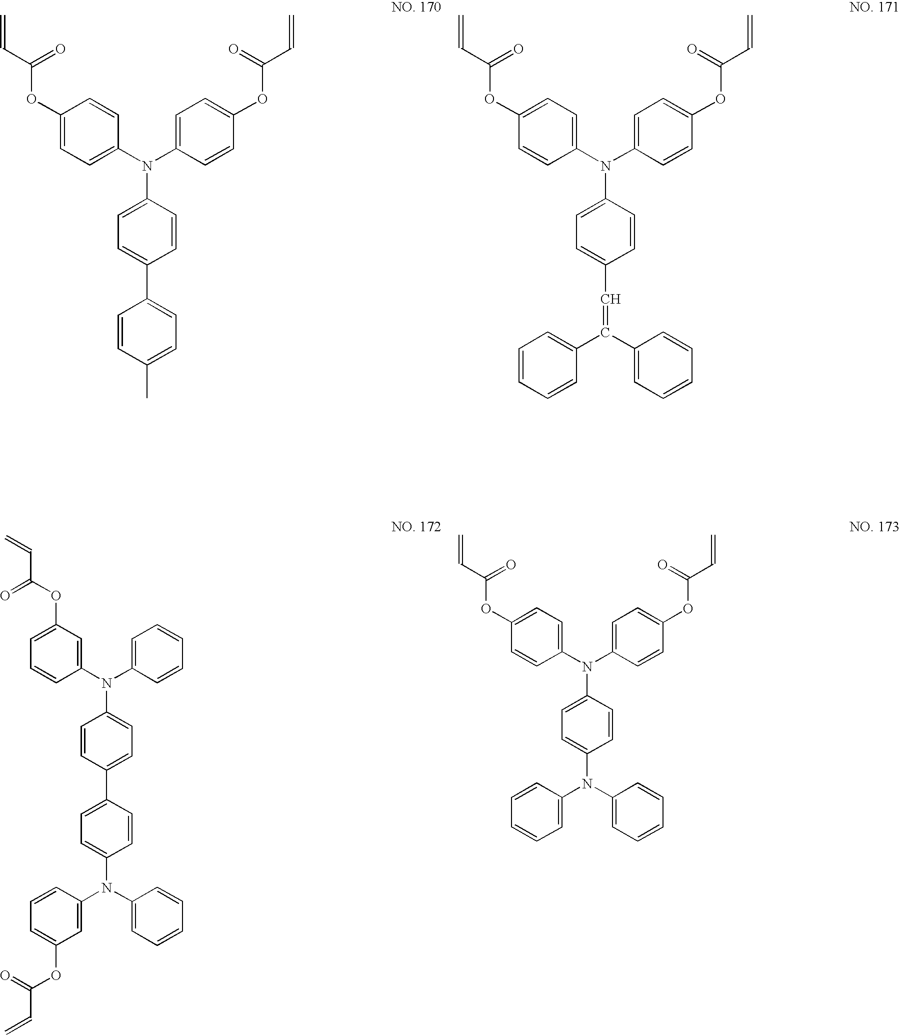

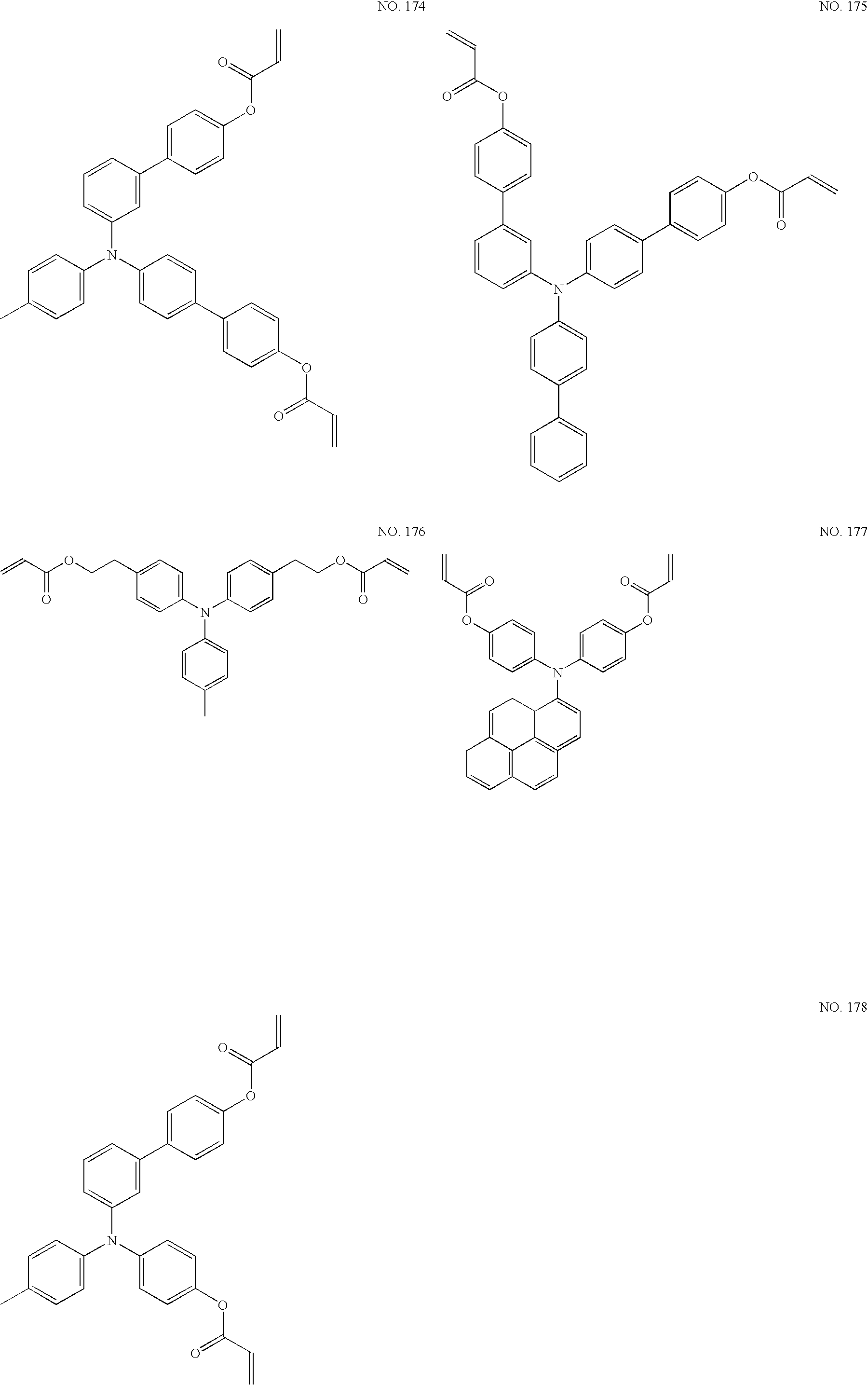

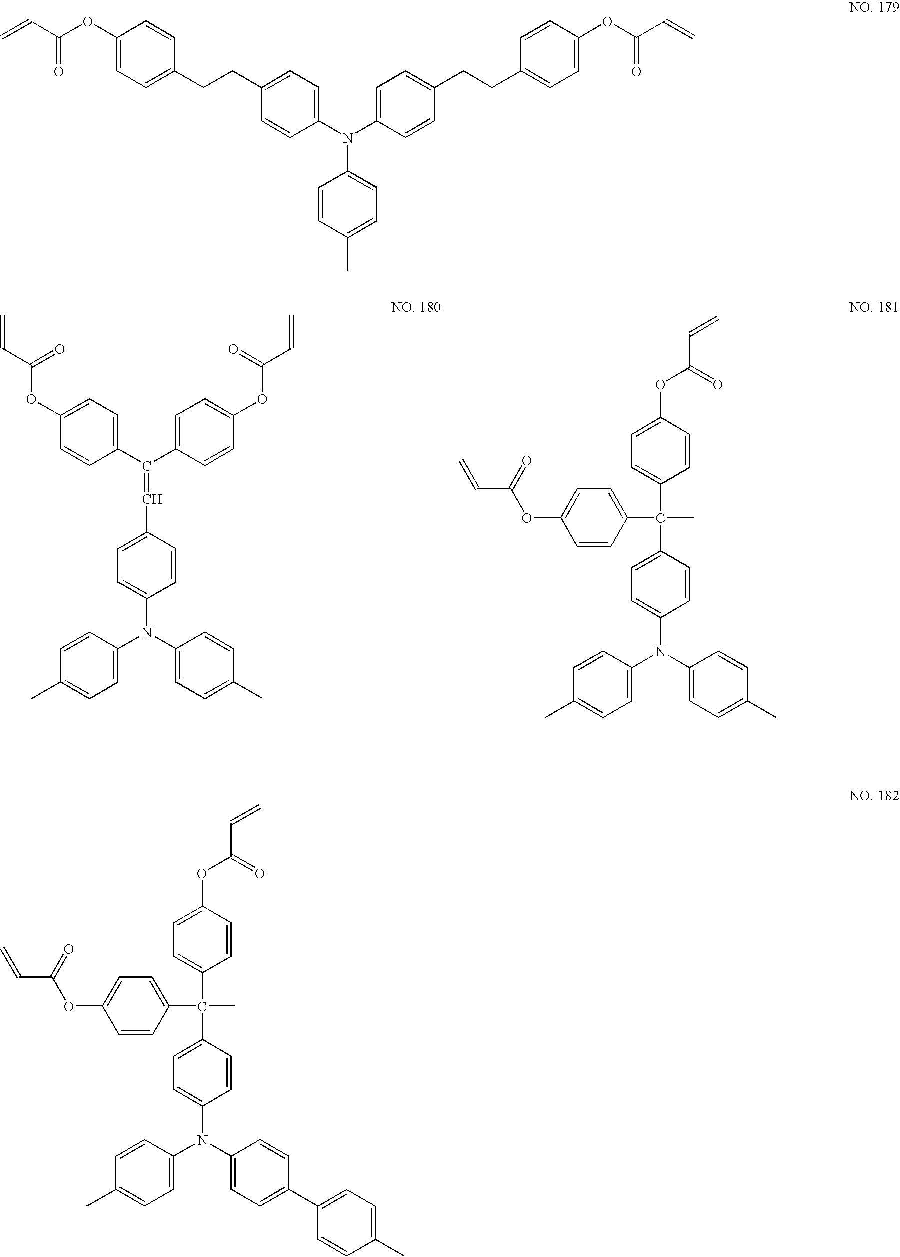

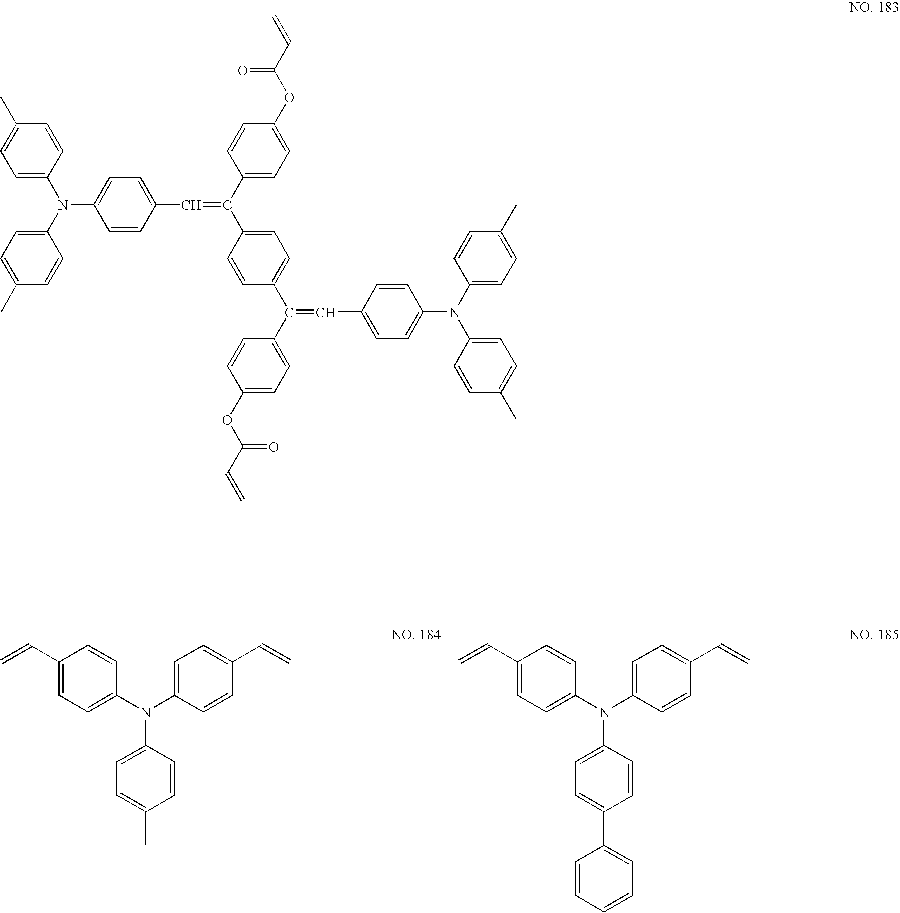

The radical polymerizable compound having a charge transporting structure for use in the present invention is essential for imparting a charge transportability to the crosslinked surface layer, and is preferably included therein in an mount of 20 to 80% by weight, and more preferable from 30 to 70% by weight based on total weight thereof. When less than 20% by weight, the crosslinked surface layer cannot maintain the charge transportability, the sensitivity of the resultant photoreceptor deteriorates and the residual potential thereof increases in repeated use. When greater than 80% by weight, the content of the tri- or more functional monomer having no charge transport structure decreases and the crosslinked density deteriorates, and therefore the resultant photoreceptor does not have sufficiently high abrasion resistance. Although it depends on the required abrasion resistance and electrical properties in consideration of a balance therebetween, a content of the monofunctional radical polymerizable compound having a charge transport structure is most preferably from 30 to 70% by weight.

The crosslinked surface layer of the present invention has a layer film density of from 1.0 to 1.4 g/cm³. The layer film density is determined by dividing the weight of the crosslinked surface layer with the volume thereof based on the thickness. In the present invention, the weight variation of the crosslinked surface layer before and after formed is measured with an electronic balance AE163 from Mettler-Toledo International Inc. and the thickness thereof is measured with Fischer Scope MMS from Fischer Instruments K.K. at 22° C. and 55% RH. Any measuring methods similar to this may be used in the present invention. A crosslinked surface layer having a layer film density of from 1.0 to 1.4 g/cm³ has a dense structure and forms a high-reliability and long-life photoreceptor having an improved environmental resistance and decreased transmittance of gas such as ozone, nitrogen oxide and moisture.

The crosslinked surface layer of the present invention preferably has a residual solvent not greater than 5,000 ppm, more preferably not greater than 1,000 ppm, and much more preferably not greater than 500 ppm when crosslinked in terms of layer film density. The less the residual solvent, the more improved the layer film density of the crosslinked surface layer.

Specific examples of the solvent include, but are not limited to, hydrocarbons such as heptane, octane, trimethylpentane, isooctane, nonane, 2,2,5-trimethylhexane, decane, benzene, toluene, xylene, ethylbenzene, isopropylbenzene, styrene, ethylcyclohexanone and cyclohexanone; alcohols such as methanol, ethanol, 1-propanol, 2-propanol, 1-butanol, 2-butanol, isobutylalcohol, tert-butylalcohol, 1-pentanol, 2-pentanol, 3-pentanol, 2-methyl-1-butanol, tert-pentylalcohol, 3-methyl-1-butanol, 3-methyl-2-butanol, neopentylalcohol, 1-hexanol, 2-methyl-1-pentanol, 4-methyl-2-pentanol, 2-ethyl-1-butanol, 3-heptanol, allylalcohol, propalgyl alcohol, benzylalcohol, cyclohexanol, 1,2-ethanodiol and 1,2-propanediol; phenols such as phenol and cresol; ethers such as dipropylether, diisopropylether, dibutylether, butylvinylether, benzylethylether, dioxane, anisole, phenetol and 1,2-epoxybutane; acetals such as acetal, 1,2-dimethoxyethane and 1,2-diethoxyethane; ketones such as methyl ethyl ketone, 2-penatnone, 2-hexanone, 2-heptanone, diisobutylketone, methyloxide, cyclohexanone, methylcyclohexanone, 4-methyl-2-pentanone, acetylacetone and acetonylacetone; esters such as ethylacetate, propylacetate, butylacetate, pentylacetate, 3-methoxybutylacetate, diethylcarbonate and 2-methoxyethylacetate; halogenated compounds such as chlorobenzene; sulfur containing compounds such as tetrahydrothiophene; compounds having plural functional groups such as 2-methoxyethanol, 2-ethoxyethanol, furfurylalcohol, tetrahydrofurfurylalcohol, 1-methoxy-2-propanol, 1-ethoxy-2-propanol, d4acetonealcohol, furfural 2-methoxyethylacetate, 2-ethoxyethylacetate propyleneglycolpropylether and propyleneglycol-1-monomethylether-2-acetate; etc. The solvent preferably has a saturated vapor pressure not less than 50 mm Hg/25° C., more preferably not less than 100 mmHg/25° C., and much more preferably not less than 150 mm Hg/25° C. to decrease the residual solvent. In terms of the saturated vapor pressure, acetone, cyclopentane, methylacetate, tetrahydrofuran and methanol are preferably used. These solvents can be used alone or in combination.

The dilution rate of the solvent is determined as desired according to the solubility of constituents, the coating method and the thickness of a layer. However, the solid contents of the coating liquid is preferably from 3 to 50% by weight, and more preferably from 10 to 30% by weight in terms of maintaining an amount of the residual solvent in the crosslinked surface layer when formed and giving the sufficient adhesiveness thereof.

The crosslinked surface layer of the present invention is formed by preparing a solution (coating liquid) comprising at least a tri- or more functional radical polymerizable monomer having no charge transport structure and a radical polymerizable compound having a charge transport structure coating and drying the solution, and hardening (crosslinking) the solution. Besides these, the coating liquid can include a monofunctional and bifunctional radical polymerizable monomer, a functional monomer and a radical polymerizable oligomer as well to control the viscosity of the surface layer when coated, reduce the stress of thereof, impart a low surface free energy thereto and reduce friction coefficient thereof. Known radical polymerizable monomers and oligomers can be used.

Specific examples of the monofunctional radical monomer include, but are not limited to, 2-ethylhexylacrylate, 2-hydroxyethylacrylate, 2-hydroxypropylacrylate, tetrahydrofurfurylacrylate, 2-ethylhexylcarbltolacrylate, 3-methoxybutylacrylate, benzylacrylate, cyclohexylacrylate, isoamylacrylate, isobutylacrylate, methoxytriethyleneglycolacrylate, phenoxytetraethyleneglycolacrylate, cetylacrylate, isostearylacrylate, stearylacrylate, styrene monomer, etc.

Specific examples of the bifunctional radical monomer include, but are not limited to, 1,3-butanediolacrylate, 1,4-butanedioldiacrylate, 1,4-butanedioldimethacrylate, 1,6-hexanedioldiacrylate, 1,6-hexanedioldimethacrylate, diethyleneglycoldiacrylate, neopentylglycoldiacrylate, EO-modified bisphenol A diacrylate, EO-modified bisphenol F diacrylate, etc.

Specific examples of the functional monomer include, but are not limited to, octafluoropentylacrylate, 2-perfluorooctylethylacrylate, 2-perfluorooctylethylmethacrylate, 2-perfluoroisononylethylacrylate, etc., wherein a fluorine atom is substituted; vinyl monomers having a polysiloxane group having a siloxane repeat unit of from 20 to 70disclosed in Japanese Patent Publications Nos. 5-60503 and 6-45770, such as acryloylpolydimethylsiloxaneethyl, methacryloylpolydimethylsiloxaneethyl, acryloylpolydimethylsiloxanepropyl, acryloylpolydimethylsiloxanebutyl and diacryloylpolydimethylsiloxanediethyl; acrylate; and methacrylate.

Specific examples of the radical polymerizable oligomer include, but are not limited to, epoxyacrylate oligomers, urethaneacrylate oligomers and polyetseracrylate oligomers.

However, when the crosslinked surface layer includes a large amount of the radical polymerizable monomer and radical polymerizable oligomer having one or two functional groups, the three-dimensional crosslinked bonding density thereof substantially deteriorates, resulting in deterioration of the abrasion resistance thereof. Therefore, the surface layer of the present invention preferably includes the monomers and oligomers in an amount not greater than 50 parts by weight, and more preferably not greater than 30 parts by weight per 100 parts by weight of the radical polymerizable monomer having three or more functional groups.

The crosslinked surface layer of the present invention is formed by preparing a solution (coating liquid) comprising at least a tri- or more functional radical polymerizable monomer having no charge transport structure and a monofunctional radical polymerizable compound having a charge transport structure, coating and drying the solution, and hardening (crosslinking) the solution. The coating liquid may optionally include a polymerization initiator such as a heat polymerization initiator and a photo polymerization initiator to effectively proceed the crosslinking reaction.

Specific examples of the heat polymerization initiator include, but are not limited to, peroxide initiators such as 2,5-dimethylhexane-2,5-dihydrooxide, dicumylperoxide, benzoylperoxide, t-butylcumylperoxide, 2,5-dimethyl-2,5-di(peroxybenzoyl)hexyne-3, di-t-butylbeloxide, t-butylhydrobeloxide, cumenehydobeloxide and lauroylperoxide; and azo initiators such as azobisisobutylnitrile, azobiscyclohexanecarbonitrile, azobisisomethylbutyrate, azobisisobutylamidinehydorchloride and 4,4′-azobis-4-cyanovaleric acid.

Specific examples of the photo polymerization initiator include, but are not limited to, acetone or ketal photo polymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-1(2-hydroxy-2-propyl)ketone, 2-benzyl-2-dimethylamino-1-(4-molpholinophenyl)butanone-1,2-hydroxy-2-methyl-1-phenylpropane-1-one and 1-phenyl-1,2-propanedion-2-(o-ethoxycarbonyl)oxime; benzoinether photo polymerization initiators such as benzoin, benzoinmethylether, benzoinethylether, benzoinisobutylether and benzoinisopropylether; benzophenone photo polymerization initiators such as benzophenone, 4-hydroxybenzophenone, o-benzoylmethylbenzoate, 2-benzoylnaphthalene, 4-benzoylviphenyl, 4-benzoylphenylether, acrylated benzophenone and 1,4-benzoylbenzene; thioxanthone photo polymerization initiators such as 2-isopropylthioxanthone, 2-chlorothioxanthone, 2,4-dimethylthioxanthone, 2,4-diethylthioxanthone and 2,4-dichlorothioxanthone; and other photo polymerization initiators such as ethylanthraquinone, 2,4,6-trimethylbenzoyldiphenylphosphineoxide, 2,4,6-trimethylbenzoyldiphenylethoxyphosphineoxide, bis(2,4,6-trimethylbenzoyl)phenylphosphineoxide, bis(2,4-dimethoxybenzoyl)-2,4,4-trimethylpentylphosphineoxi de, methylphenylglyoxyester, 9,10-phenanthrene, acridine compounds, triazine compounds and imidazole compounds. Further, a material having a photo polymerizing effect can be used alone or in combination with the above-mentioned photo polymerization initiators. Specific examples of the materials include, but are not limited to, triethanolamine, methyldiethanol amine, 4-dimethylaminoethylbenzoate, 4-dimethylaminoisoamylbenzoate, ethyl(2-dimethylamino)benzoate and 4,4-dimethylaminobenzophenone.

These polymerization initiators can be used alone or in combination. The crosslinked surface layer of the present invention preferably includes the polymerization initiators in an amount of 0.5 to 40 parts by weight, and more preferably from 1 to 20 parts by weight per 100 parts by weight of the radical polymerizable compounds.

Further, the coating liquid may optionally include various additives such as plasticizers (to soften a stress and improve adhesiveness thereof), leveling agents and low-molecular-weight charge transport materials without a radical reactivity. Known additives can be used and specific examples of the plasticizers include, but are not limited to, plasticizers such as dibutylphthalate and dioctylphthalate used in typical resins. The content thereof is preferably not greater than 20% by weight, and more preferably not greater than 10% based on total weight of solid contents of the coating liquid. Specific examples of the leveling agents include, but are not limited to, silicone oil such as dimethylsilicone oil and methylphenylsillcone oil and polymers and oligomers having a perfluoroalkyl group in the side chain. The content thereof is preferably not greater than 3% by weight.

The crosslinked surface layer can be formed by any desired method, including, but not limited to, a dip coating method, a spray coating method, a bead coating method, a ring coating method, etc. The spray coating method is preferably used because of being able to control the amount of residual solvent in the crosslinked surface layer when formed.

In the present invention, after the coating liquid is coated to form a layer, external energy is applied thereto for hardening the layer to form the crosslinked surface layer. Before hardening the layer, the layer may be de-solvented. Any known de-solvent methods can be used, however, a simple drying by heating method at a normal pressure or under a reduced pressure is preferably used. The drying temperature is preferably not higher than 170° C. The drying time depends on the drying temperature and residual solvent, and is preferably not longer than 24 hrs such that constituents of the crosslinked surface layer are not crystallized or separated out.

The external energy includes, but is not limited to, heat, light and radiation energy. Heat energy is applied to the layer from the coated side or from the substrate using air, a gaseous body such as nitrogen a steam, a variety of heating media, infrared or an electromagnetic wave. The heating temperature is preferably from 100 to 170° C. When less than 100° C., the reaction is slow in speed and is not completely finished. When greater than 170° C., the reaction nonuniformly proceeds and a large distortion appears in the crosslinked surface layer. To obtain a uniform hardening reaction, after heating at comparatively a low temperature less than 100° C., the reaction is effectively completed at not less than 100° C. Specific examples of the light energy include, but are not limited to, UV irradiators such as high pressure mercury lamps and metal halide lamps having an emission wavelength of UV light; and a visible light source adaptable to absorption wavelength of the radical polymerizable compounds and photo polymerization initiators. The irradiation light quantity is preferably from 50 to 1000 mW/cm². When less than 50 mW/cm², the hardening reaction takes too long. When greater than 1,000 mW/cm², the reaction proceeds nonuniformly and the crosslinked surface layer has a large surface roughness. The radiation energy includes radiation energy using an electron beam. Among these energies, heat and light energies are effectively used because of their simple reaction speed controls and simple apparatuses.

Since the crosslinked surface layer of the present invention has a different thickness depending on a layer structure of a photoreceptor using the crosslinked surface layer, the thickness will be explained according to the following explanations of the layer structures.

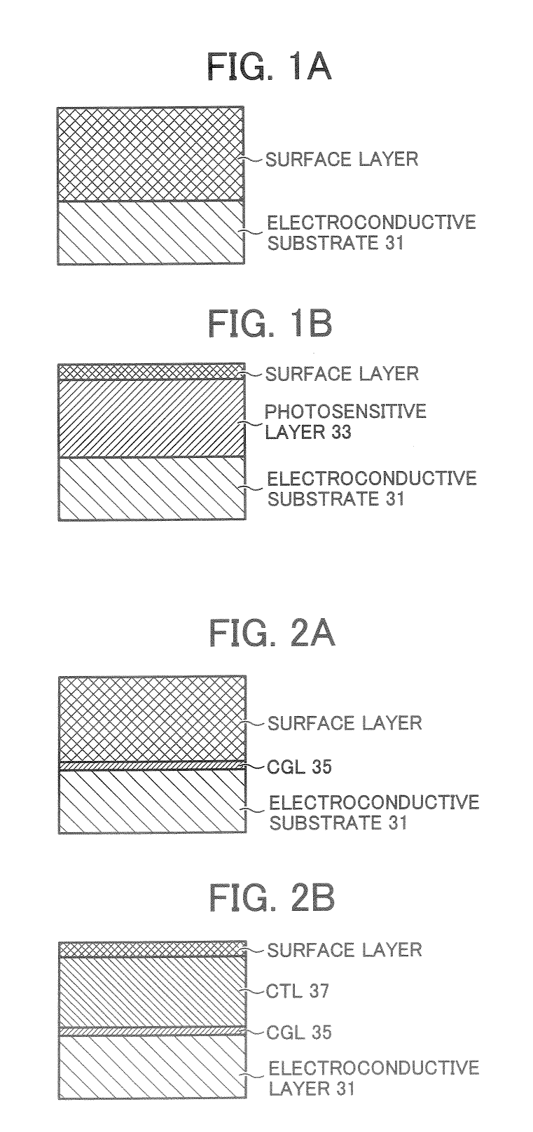

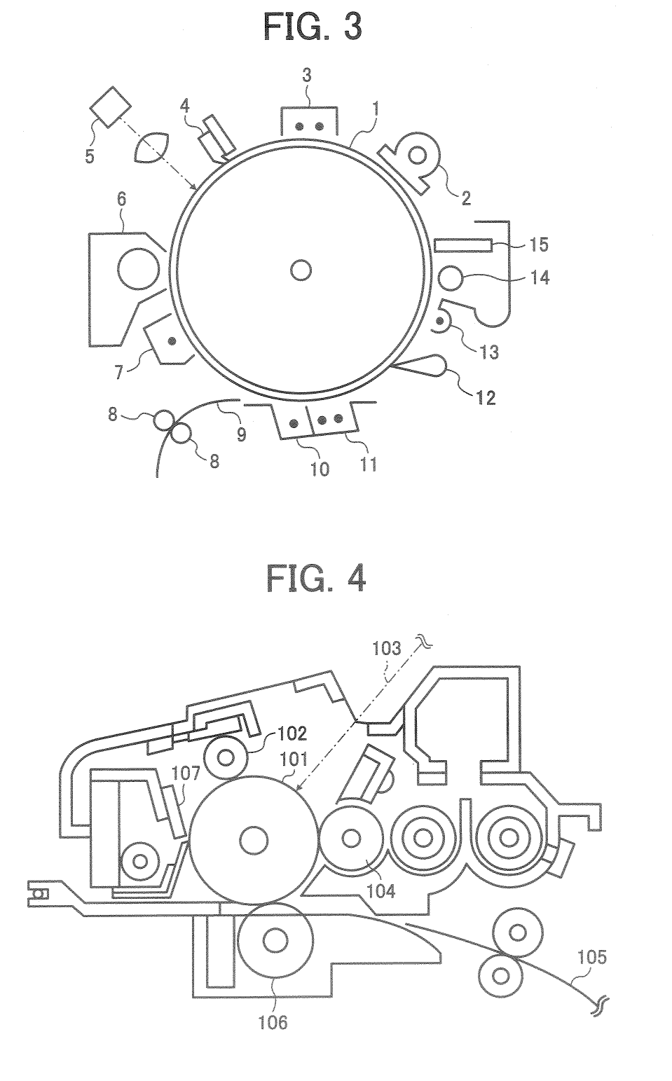

The electrophotographic photoreceptor for use in the present invention will be explained, referring to the drawings FIGS. 1A and 1B are cross-sectional views of embodiments of layers of the electrophotographic photoreceptor of the present invention, which is a single-layered photoreceptor formed of a photosensitive layer (33) having both a charge generation function and charge transport function and overlying an electroconductive substrate (31). In FIG. 1A, the photosensitive layer is wholly crosslinked and hardened to form a crosslinked surface layer. In FIG. 1B a crosslinked surface layer is formed at the surface of the photosensitive layer.

FIGS. 2A and 2B are cross-sectional views of other embodiments of layers of the electrophotographic photoreceptor of the present invention, which is a multilayered photoreceptor formed of a charge generation layer (35) having a charge generation function and a charge transport layer (37) having a charge transport function, and which are overlying an electroconductive substrate (31). In FIG. 2A, the charge transport layer is wholly crosslinked and hardened to form a crosslinked surface layer. In FIG. 2B, a crosslinked surface layer is formed at the surface of the charge transport layer.

Suitable materials for use as the electroconductive substrate (31) include materials having a volume resistance not greater than 10¹⁰Ω·cm. Specific examples of such materials include, but are not limited to, plastic cylinders, plastic films or paper sheets, on the surface of which a metal such as aluminum, nickel, chromium, nichrome, copper, gold, silver, platinum and the like, or a metal oxide such as tin oxides, indium oxides and the like, is deposited or sputtered. In addition, a plate of a metal such as aluminum, aluminum alloys, nickel and stainless steel and a metal cylinder, which is prepared by tubing a metal such as the metals mentioned above by a method such as impact ironing or direct ironing, and then treating the surface of the tube by cutting, super finishing, polishing and the like treatments, can also be used as the substrate. Further, endless belts of a metal such as nickel and stainless steel, which have been disclosed in Published Unexamined Japanese Patent Application No 52-36016, can also be used as the substrate (31).

Furthermore, substrates, in which a coating liquid including a binder resin and an electroconductive powder is coated on the supporters mentioned above, can be used as the substrate (31).

Specific examples of such an electroconductive powder include, but are not limited to, carbon black, acetylene black, powders of metals such as aluminum nickel, iron, Nichrome, copper, zinc, silver and the like, and metal oxides such as electroconductive tin oxides, ITO and the like. Specific examples of the binder resin include, but are not limited to, known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyl resins and the like resins. Such an electroconductive layer can be formed by coating a coating liquid in which an electroconductive powder and a binder resin are dispersed in a solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and TEFLON (registered trademark) with an electroconductive material, can also be preferably used as the substrate (31).

Next, the photosensitive layer will be explained. The photosensitive layer may be single-layered or multilayered. The multilayered photosensitive layer is formed of a charge generation layer having a charge generation function and a charge transport layer having a charge transport function. The single-layered photosensitive layer is a layer having both the charge generation function and charge transport function.

Hereinafter, the multilayered photosensitive layer and single-layered photosensitive layer will be explained respectively.

The charge generation layer (CGL) (35) is mainly formed of a charge generation material, and optionally includes a binder resin. Suitable charge generation materials include inorganic materials and organic materials.

Specific examples of the inorganic charge generation materials include, but are not limited to, crystalline selenium, amorphous selenium, selenium-tellurium alloys, selenium-tellurium-halogen alloys, selenium-arsenic alloys, amorphous silicon, etc. The amorphous silicon includes a dangling bond terminated with a hydrogen atom or a halogen atom, a doped boron atom, a doped phosphorus atom, etc.

Specific examples of the organic charge generation materials include known materials, for example, phthalocyanine pigments such as metal phthalocyanine and metal-free phthalocyanine, azulenium pigments, squaring acid methine pigments, azo pigments having a carbazole skeleton, azo pigments having a triphenylamine skeleton, azo pigments having a diphenylamine skeleton, azo pigments having a dibenzothiophene skeleton azo pigments having a fluorenone skeleton azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone pigments polycyclic quinone pigments, quinoneimine pigments, diphenyl methane pigments, triphenyl methane pigments, benzoquinone pigments, naphthoquinone pigments, cyanine pigments, azomethine pigments, indigoid pigments, bisbenzimidazole pigments, etc.

These charge generation materials can be used alone or in combination.

Specific examples of the binder resin optionally used in the CGL (35) include, but are not limited to, polyamide resins, polyurethane resins, epoxy resins, polyketone resins, polycarbonate resins, silicone resins, acrylic resins, polyvinyl butyral resins, polyvinyl formal resins, polyvinyl ketone resins, polystyrene resins, poly-N-vinylcarbazole resins, polyacrylamide resins, and the like resins. These resins, can be used alone or in combination. In addition, a charge transport polymer material can also be used as the binder resin in the CGL besides the above-mentioned binder resins. Specific examples thereof include, but are not limited to, polymer materials such as polycarbonate resins, polyester resins, polyurethane resins, polyether resins, polysiloxane resins and acrylic resins having an arylamine skeleton, a benzidine skeleton, a hydrazone skeleton, a carbazole skeleton, a stilbene skeleton, a pyrazoline skeleton, etc.; and polymer materials having polysilane skeleton.

Specific examples of the former polymer materials include, but are not limited to, charge transport polymer materials disclosed in Published Unexamined Japanese Patent Applications Nos. 01-001728, 01-009964, 01-013061, 01-019049, 01-241559, 04-011627, 04-175337, 04-183719, 04-225014, 04-230767, 04-320420 05-232727, 05-310904 06-234838, 06-234839, 06-234840, 06-234839, 06-234840, 06-234841, 06-236051, 06-295077, 07-056374, 08-176293, 08-208820, 08-211640, 08-253568, 08-269183, 09-062019, 09-043883, 09-71642, 09-87376, 09-104746, 09-110974, 09-110976, 09-157378, 09-221544, 09-227669, 09-235367, 09-241369, 09-268226, 09-272735, 09-302084, 09-302085, 09-328539, etc., the contents of each of which are hereby incorporated by reference.

Specific examples of the latter polymer materials include, but are not limited to, polysilylene polymers disclosed in Published Unexamined Japanese Patent Applications Nos. 63-285552, 05-19497, 05-70595, 10-73944, etc, the contents of each of which are hereby incorporated by reference.

The CGL (35) can also include a low-molecular-weight charge transport material.

The low-molecular-weight charge transport materials include positive hole transport materials and electron transport materials.

Specific examples of the electron transport materials include, but are not limited to, electron accepting materials such as chloranil, bromanil, tetracyanoethylene, tetracyanoquinodimethane, 2,4, -trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno [1,2-b]thiophene-4-one, 1,3,7-trinitrobenzothiophene-5,5-dioxide, diphenoquinone derivatives, etc. These electron transport materials can be used alone or in combination.

Specific examples of the positive hole transport materials include, but are not limited to, electron donating materials such as oxazole derivatives, oxadiazole derivatives, imidazole derivatives, monoarylamines derivatives, diarylamine derivatives, triarylamine derivatives/stilbene derivatives, α-phenylstilbene derivatives, benzidine derivatives diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, and other known materials. These positive hole transport materials can be used alone or in combination.

Suitable methods for forming the charge generation layer (35) are broadly classified into a vacuum thin film forming method and a solvent dispersion casting method.

Specific examples of the former vacuum thin film forming method include, but are not limited to, a vacuum evaporation method, a glow discharge decomposition method, an ion plating method, a sputtering method, a reaction sputtering method, CVD (chemical vapor deposition) methods, etc. A layer of the above-mentioned inorganic and organic materials can be formed by these methods.

The casting method for forming the charge generation layer typically includes the following steps:

(1) preparing a coating liquid by mixing one or more inorganic or organic charge generation materials mentioned above with a solvent such as tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate, butyl acetate, etc., optionally with a binder resin and a leveling agent such as a dimethylsilicone oil and methylphenyl silicone oil, and then dispersing the materials with a ball mill, an attritor, a sand mill, a bead mill, etc. to prepare a CGL coating liquid;

(2) coating the CGL coating liquid, which is diluted if necessary, on a substrate by a method such as dip coating, spray coating, bead coating and ring coating; and

(3) drying the coated liquid to form a CGL.

The thickness of the CCG is preferably from 0.01 to 5 μm, and more preferably from 0.05 to 2 μm.

The charge transport layer (CTL) (37) is a layer having charge transportability, and the crosslinked surface layer (32) of the present invention is effectively used as a CTL. When the crosslinked surface layer (32) is a whole CTL (37), as mentioned above, after a coating liquid including the tri- or more functional radical polymerizable monomer having no charge transporting structure and the radical polymerizable compound having a charge transport structure (hereinafter referred to as radical polymerizable compositions) of the present invention is coated on the CGL (35) and is optionally dried to form a coated layer thereon, and external energy is applied thereto to harden (or cure) the coated layer to form the crosslinked surface layer. The crosslinked surface layer preferably has a thickness of from 10 to 30 μm, and more preferably from 10 to 25 μm. When thinner than 10 μm, a sufficient charged potential cannot be maintained. When thicker than 30 μm, a contraction in volume thereof when hardened tends to cause separation thereof from a lower layer

When the crosslinked surface layer is formed on the surface of the CTL (37) as shown in FIG. 23, the CTL (37) is formed by coating the CGL (35) with a coating liquid wherein a charge transport material having charge transportability and a binder resin are dispersed in a proper solvent to form a coated layer thereon, and drying the coated layer. The crosslinked surface layer is formed by coating the CTL (37) with a coating liquid including the above-mentioned radical polymerizable compositions of the present invention to form a coated layer thereon, and crosslinking and hardening the coated layer with external energy.

Specific examples of the charge transport materials include, but are not limited to, electron transport materials, positive hole transport materials and charge transport polymer materials used in the CGL (35). Particularly, the charge transport polymer materials are effectively used to reduce dissolution of a lower layer when a surface layer is coated thereon.

Specific examples of the binder resins include, but are not limited to, thermoplastic or thermosetting resins such as a polystyrene resin, a styrene-acrylonltrile copolymer, a styrene-butadiene copolymer, a styrene-maleic anhydride copolymer, a polyester resin, a polyvinylchloride resin, a vinylchloride-vinylacetate copolymer a polyvinylacetate resin a polyinylidenechloride resin, a polyarylate resin, a phenoxy resin, a polycarbonate resin, a cellulose acetate resin, an ethylcellulose resin, a polvinylbutyral resin, a polyinylformal resin, a polypvinyltoluene resin, a poly-N-vinylcarbazole resin, an acrylic resin, a silicone resin, an epoxy resin, a melamine resin, a urethane resin, a phenol resin and an alkyl resin.

The CTL shown in FIG. 2B preferably includes the charge transport material in an amount of from 20 to 300 parts by weight and more preferably from 40 to 150 parts by weight per 100 parts by weight of the binder resin. However, the charge transport polymer material can be used alone or in combination with the binder resin.

Specific examples of a solvent used for coating the CTL (37) shown in FIG. 2B include, but are not limited to the solvents used for coating the CGL (35), and particularly solvents that can dissolve the charge transport material and binder resin well are preferably used. These solvents can be used alone or in combination. The CTL shown in FIG. 2B can be formed by the same coating methods used for coating the CGL (35).

The CTL (37) shown in FIG. 2B may optionally include a plasticizer and a leveling agent.

Specific examples of the plasticizer include, but are not limited to, plasticizers for typical resins, such as dibutylphthalate and dioctylphthalate, and the content thereof is preferably from 0 to 30 parts by weight per 100 parts by weight of the binder resin.

Specific examples of the leveling agents include, but are not limited to, silicone oil such as dimethyl silicone oil and methylphenyl silicone oil; and polymers or oligomers having a perfluoroalkyl group in the side chain, and the content thereof is preferably from 0 to 1 part by weight per 100 parts by weight of the binder resin.

The CTL (37) shown in FIG. 2B preferably has a thickness of from 5 to 40 μm, and more preferably from 10 to 30 μm.

When the crosslinked surface layer (32) shown in FIG. 2B overlies the CTL (37), as mentioned in the method of forming a crosslinked surface layer, a coating liquid including the radical polymerizable compositions of the present invention is coated on the CTL and optionally dried to form a coated layer thereon, and external energy is applied thereto to harden (cure) the coated layer to form the crosslinked surface layer thereon. The crosslinked surface layer preferably has a thickness of from 1 to 20 μm and more preferably from 2 to 10 μm. When thinner than 1 μm uneven thickness thereof causes uneven durability thereof. When thicker than 20 μm, the total thickness of the CTL (37) and crosslinked surface layer is so thick that charges are scattered, resulting in deterioration of image reproducibility of the resultant photoreceptor.

The single-layered photosensitive layer has both a charge generation function and a charge transport function and the crosslinked surface layer having a charge transporting structure and including a charge generation material having a charge generating function of the present invention is effectively used as a single-layered photosensitive layer as shown in FIG. 1A. As mentioned in the casting method of forming the CGL (35), a charge generation material is dispersed in a coating liquid including the radical polymerizabie compositions, and the coating liquid is coated on an electroconductive substrate and optionally dried to form a coated layer thereon, then a hardening (curing) reaction is performed in the coated layer with external energy to form the crosslinked surface layer. The charge generation material may previously be dispersed in a solvent to prepare a dispersion, and the dispersion may be added into the coating liquid for forming the crosslinked surface layer The crosslinked surface layer preferably has a thickness of from 10 to 30 μm, and more preferably from 10 to 25 μm. When thinner than 10 μm, a sufficient charged potential cannot be maintained. When thicker than 30 μm, a contraction in volume thereof when hardened tends to cause a separation thereof from an undercoat layer.

When the crosslinked surface layer overlies a single-layered photosensitive layer as shown in FIG. 1B, an underlayer of the photosensitive layer can be formed by dissolving or dispersing a charge generatable charge generation material, a charge transportable charge transport material and a binder resin in a proper solvent to prepare a solution or a dispersion, and coating and drying the solution or dispersion. A plasticizer, a leveling agent, etc. can optionally be added thereto. The method of dispersing the charge generation material, the charge transport material, the plasticizer and the leveling agent are mentioned above in the charge generation layer (35) and the charge transport layer (37). The binder resin used in the charge transport layer (37) and the charge generation layer (35) can be used. In addition, the charge transport polymer material can effectively be used in terms of decreasing incorporation of the constituents of the lower photosensitive layer in the crosslinked surface layer. The underlayer of the photosensitive layer preferably has a thickness of from 5 to 30 μm, and more preferably from 10 to 25 μm.

When the crosslinked surface layer overlies a single-layered photosensitive layer, as mentioned in the method of forming a crosslinked surface layer, a coating liquid including the radical polymerizable compositions of the present invention and a binder resin is coated on the photosensitive layer and optionally dried to form a coated layer thereon, and external energy is applied thereto to harden (cure) the coated layer to form the crosslinked surface layer thereon. The crosslinked surface layer preferably has a thickness of from 1 to 20 μm, and more preferably from 2 to 10 μm. When thinner than 1 μm, uneven thickness thereof causes uneven durability thereof.

The single-layered photosensitive layer preferably includes a charge generation material in an amount of from 1 to 30% by weight, a binder resin of from 20 to 80% by weight and a charge transport material of from 10 to 70 parts by weight based on total weight thereof.

The photoreceptor of the present invention can have an intermediate layer between a crosslinked surface layer and a photosensitive layer when the crosslinked surface layer overlies the photosensitive layer. The intermediate layer prevents components of the lower photosensitive layer from mixing in the crosslinked surface layer to avoid inhibition of the hardening reaction and concavities and convexities of the layer. In addition, the intermediate layer can improve the adhesiveness between the crosslinked surface layer and photosensitive layer.

The intermediate layer includes a resin as a main component. Specific examples of the resin include, but are not limited to, polyamides, alcohol-soluble nylons, water-soluble polyvinyl butyral, polyvinyl butyral, polyvinyl alcohol, etc. The intermediate layer can be formed by one of the above-mentioned known coating methods. The intermediate layer preferably has a thickness of from 0.05 to 2 μm.

The photoreceptor of the present invention may have an undercoat between the substrate (31) and photosensitive layer. The undercoat layer includes a resin as a main component. Since a photosensitive layer is typically formed on the undercoat layer by coating a liquid including an organic solvent, the resin in the undercoat layer preferably has good resistance to general organic solvents. Specific examples of such resins include, but are not limited to, water-soluble resins such as polyvinyl alcohol resins, casein and polyacrylic acid sodium salts; alcohol soluble resins such as nylon copolymers and methoxymethylated nylon resins; and thermosetting resins capable of forming a three-dimensional network such as polyurethane resins, melamine resins, alkyl-melamine resins, epoxy resins and the like. The undercoat layer may include a fine powder of metal oxides such as titanium oxide, silica, alumina, zirconium oxide, tin oxide and indium oxide to prevent occurrence of moiré in the recorded images and to decrease residual potential of the photoreceptor.

The undercoat layer can also be formed by coating a coating liquid using a proper solvent and a proper coating method similarly to those for use in formation of the photosensitive layer mentioned above. The undercoat layer may be formed using a silane coupling agent, titanium coupling agent or a chromium coupling agent. In addition, a layer of aluminum oxide which is formed by an anodic oxidation method and a layer of an organic compound such as polyparaxylylene (parylene) or an inorganic compound such as SiO, SnO₂, TiO₂, ITO or CeO₂ which is formed by a vacuum evaporation method is also preferably used as the undercoat layer. Besides these materials, known materials can be used. The thickness of the undercoat layer is preferably from 0 to 5 μm.

In the present invention, an antioxidant can be included in each of the layers, i.e., the crosslinked surface layer charge generation layer, charge transport layer, undercoat layer and intermediate layer to improve the stability to withstand environmental conditions namely to avoid decrease of photosensitivity and increase of residual potential.

Specific examples of the antioxidant for use in the present invention include, but are not limited to, the following compounds:

(Phenolic Compounds)

2,5-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-d-t-butyl-4-h-droxybenzy-)b enzene, tetrakis-[methylene-3-(3′,5′-di-t-butyl-4′-hydroxyphenyl)pr opionate]methane, bis[3,3′-bis(4′-hydroxy-3′-t-butylphenyl)butyric acid]glycol ester, tocophenol compounds, etc

(Paraphenylenediamine Compounds)

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

(Hydroquinone Compounds)

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl) -5-methylhydroquinone, etc.

(Organic Sulfur-Containing Compounds)

Dilauryl-3,3′-thiodipropionate, distearyl-3,3′-thiodipropionate, ditetradecyl-3,3′-thiodipropionate, etc.

(Organic Phosphorus-Containing Compounds)

Triphenylphosphine, tri(nonylphenyl)phosphine, tri(dinonylphenyl)phosphine, tricresylphosphine, tri(2,4-dibutylphenoxy)phosphine, etc

These compounds are known as antioxidants for rubbers, plastics, fats, etc., and marketed products thereof can easily be obtained.

Each of the layers preferably includes the antioxidant in an amount of from 0.01 to 10% by weight based on total weight thereof.

Next, the image forming method and image forming apparatus of the present invention will be explained in detail, referring to the drawings.

The image forming method and image forming apparatus of the present invention include a photoreceptor having a smooth transporting crosslinked surface layer having a low surface energy, wherein the photoreceptor is charged and irradiated with an imagewise light to form an electrostatic latent image thereon; the electrostatic latent image is developed to form a toner image; the toner image is transferred onto an image bearer (transfer sheet) and fixed thereon; and a surface of the photoreceptor is cleaned.

The process is not limited thereto in such a method as to directly transfer an electrostatic latent image onto a transfer sheet and develop the electrostatic latent image thereon.

A charger (3) is used to uniformly charge a photoreceptor (1). Specific examples of the charger include, but are not limited to, known chargers such as a corrosion device, a scorotron device, a solid state charger, a needle electrode device, a roller charging device and an electroconductive brush device.

Contact chargers or non-contact chargers can be used in the present invention. The contact chargers include, but are not limited to, a charging roller, a charging brush, a charging blade, etc. directly contacting a photoreceptor. The non-contact chargers include, e.g., a charging roller located close to a photoreceptor with a gap not longer than 200 μm therebetween. When the gap is too long, the photoreceptor is not stably charged. When too short, the charging member, e.g., a charging roller, is contaminated with a toner remaining on the photoreceptor. Therefore, the gap preferably has a length of from 10 to 200 μm and more preferably from 10 to 100 μm.

Next, an imagewise irradiator (5) is used to form an electrostatic latent image on the photoreceptor (1). Suitable light sources thereof include, but are not limited to, typical light emitters such as a fluorescent lamp, a tungsten lamp, a halogen lamp, a mercury lamp, a sodium lamp, a light emitting diode (LED), a laser diode (LD), a light source using electroluminescence (EL), etc. In addition, to obtain light having a desired wave length range, filters such as a sharp-cut filter, a band pass filter, a near-infrared cutting filter, a dichroic filter, an interference filter and a color temperature converting filter can be used.

Next, a developing unit (6) is used to visualize an electrostatic latent image formed on the photoreceptor (1). The developing methods include a one-component developing method and a two-component developing method using a dry toner; and a wet developing method using a wet toner. When the photoreceptor positively or negatively charged is exposed to imagewise light, an electrostatic latent image having a positive or negative charge is formed on the photoreceptor. When the latent image having a positive charge is developed with a toner having a negative charge, a positive image can be obtained. In contrast, when the latent image having a positive charge is developed with a toner having a positive charge, a negative image can be obtained.

Next, a transfer charger (10) is used to transfer a toner image visualized on the photoreceptor onto a transfer sheet (9) A pre-transfer charger (7) may be used to perform the transfer better. Suitable transferers includes but are not limited to, a transferer charger, an electrostatic transferer using a bias roller, an adhesion transferer, a mechanical transferer using a pressure and a magnetic transferer. The above-mentioned chargers can be used for the electrostatic transferer.

Next, a separation charger (11) and a separation pick (12) are used to separate the transfer sheet (9) from the photoreceptor (1). Other separation means include, but are not limited to, an electrostatic absorption induction separator, a side-edge belt separator, a tip grip conveyor, a curvature separator etc. The above-mentioned chargers can be used for the separation charger (11).

Next, a fur brush (14) and a cleaning blade (15) are used to remove a toner left on the photoreceptor after transferred therefrom. A pre-cleaning charger (13) may be used to perform the cleaning more effectively. Other cleaners include, but are not limited to, a web cleaner, a magnet brush cleaner, etc., and these cleaners can be used alone or in combination.

Next, a discharger is optionally used to remove a latent image in the photoreceptor. The discharger includes a discharge lamp (2) and a discharger, and the above-mentioned light sources and chargers can be used respectively.

Known means can be used for other parts of the process, such as an original reading process, a paper feeding process, a fixing process, a paper delivering process, etc.

The above-mentioned image forming unit may be fixedly set in a copier, a facsimile or a printer. However, the image forming unit may alternatively be detachably set therein as a process cartridge. FIG. 4 is a schematic view illustrating an embodiment of the process cartridge of the present invention.

The process cartridge means an image forming unit (or device) which includes a photoreceptor (101) and at least one of a charger (102), an image developer (104), a transferer (106) a cleaner (107) and a discharger (not shown).

While the photoreceptor (101) rotates in a direction indicated by an arrow, the photoreceptor (101) is charged by the charger (102) and irradiated by an irradiator (103) to form an electrostatic latent image relevant to imagewise light thereon. The electrostatic latent image is developed by the image developer (104) with a toner to form a form a toner image, and the toner image is transferred by the transferer (106) onto a transfer sheet (105) to be printed out. Next, a surface of the photoreceptor after the toner image is transferred is cleaned by the cleaner (107), discharged by a discharger (not shown) and these processes are repeated again.

The present invention provides a process cartridge for image forming apparatus, including a photoreceptor having a smooth charge transportable crosslinked surface layer, and at least one of s charger, an image developer, a transferer, a cleaner and a discharger.

As is apparent from the explanations mentioned above, the electrophotographic photoreceptor of the present invention can be used widely in electrophotography applied fields such as a laser beam printer, a CRT printer, a LED printer, a liquid crystal printer and a laser engraving.

<Synthesis Example of a Radical Polymerizable Compound Having a Charge Transport Structure>

The compound having a charge transporting structure of the present invention is synthesized by, e.g., a method disclosed in Japanese Patent No. 3164426. The following method is one of the examples thereof.

(1) Synthesis of a Hydroxy Group Substituted Triarylamine Compound Having the following Formula B

113.85 g (0.3 mol) of a methoxy group substituted triarylamine compound having the formula A, 138 g (0.92 mol) of sodium iodide and 240 ml of sulfolane are mixed to prepare a mixture. The mixture is heated to have a temperature of 60° C. in a nitrogen stream.

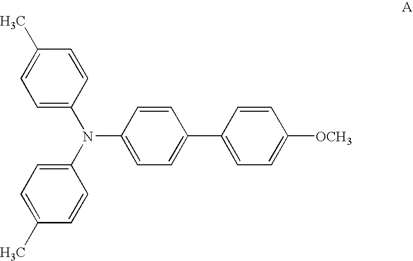

99 g (0.91 mol) of trimethylchlorosilane are dropped therein for 1 hr and the mixture is stirred for 4 hrs at about 60° C. About 1.5 L of toluene are added thereto and the mixture cooled to room temperature, and repeatedly washed with water and an aqueous solution of sodium carbonate. Then, the solvent is removed therefrom and refined by a column chromatographic process using silica gel as an absorption medium, and toluene and ethyl acetate (20-to-1) as a developing solvent. Cyclohexane is added to the thus prepared buff yellow oil to separate a crystal out. Thus, 88.1 g (yield of 80.4%) of a white crystal having the following formula B and a melting point of from 64.0 to 66.0° C. is prepared.

| | |
|---|---|
| | B |
| 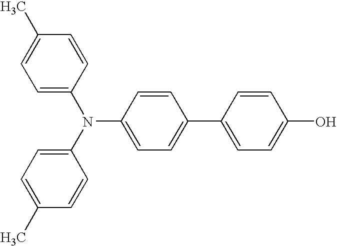 | |

Elemental Analysis Value (%)

| | C | H | N |
|---|---|---|---|
| Found value | 85.06 | 6.41 | 3.73 |
| Calculated value | 85.44 | 6.34 | 3.83 |

(2) A triarylamino group substituted acrylate compound (Compound No. 54)

82.9 g (0.227 mol) of the hydroxy group substituted triarylamine compound having the formula B prepared in (1) are dissolved in 400 ml of tetrahydrofuran to prepare a mixture, and an aqueous solution of sodium hydrate formed of 12.4 g of NaOH and 100 mil of water is dropped therein in a nitrogen stream. The mixture is cooled to have a temperature of 20° C., and 25.2 g (0.272 mol) of chloride acrylate is dropped therein for 40 min. Then, the mixture is stirred at 5° C. for 3 hrs. The mixture is put in water and extracted with toluene. The extracted liquid is repeatedly washed with water and an aqueous solution of sodium carbonate. Then, the solvent is removed therefrom and refined by a column chromatographic process using silica gel as an absorption medium and toluene as a developing solvent. N-hexane is added to the thus prepared colorless oil to separate a crystal out. Thus, 80.73 g (yield of 84.8%) of a white crystal of the compound No. 54 having a melting point of from 117.5 to 119.0° C. is prepared.

Elemental Analysis Value (%)

| | C | H | N |
|---|---|---|---|
| Found value | 83.13 | 6.01 | 3.16 |
| Calculated value | 83.02 | 6.00 | 3.33 |

(3) synthesis example of an acrylic acid ester compound

(i) Preparation of diethyl 2-hydroxybenzylphosphonate

38.4 g of 2-hydroxybenzylalcohol from TOKYO KASEI KOGYO Co., Ltd. and 80 ml of o-xylene are put in a reaction reservoir having a mixer, a thermometer and a dropping funnel. Under a nitrogen stream, 62.8 g of triethyl phosphite are slowly dropped therein at 80° C., and the reaction therein is further performed for 1 hr at the same temperature. Then, the produced ethanol, o-xylene and unreacted triethyl phosphite are removed from the reaction by reduced-pressure distillation to prepare 66 g of 2-diethylhydroxybenzylphosphonate at a yield of 90%, having a boiling point of 120.0° C./1.5 mm Hg.

(ii) Preparation of 2-hydroxy-4′-(di-para-tolylamino)stilbene

14.8 g of potassium-tert-butoxide and 50 ml of tetrahydrofuran are put in a reaction reservoir having a mixer, a thermometer and a dropping funnel. Under a nitrogen stream a solution wherein 9.90 g of the diethyl 2-hydroxybenzylphosphonate and 5.44 g of 4-(di-para-tolylamino)benzaldehyde are dissolved in tetrahydrofuran is slowly dropped therein at room temperature and the reaction therein is further performed for 2 hrs at the same temperature. Then, water is added therein while cooling the reaction product with water, a 2N hydrochloric acid solution is added therein to acidize the reaction product, and the tetrahydrofuran is removed by an evaporator to extract a crude product with toluene. The toluene phase is washed with water, a sodium hydrogen carbonate solution and a saturated saline in this order, and magnesium sulfate is further added thereto to dehydrate the toluene phase.

After filtering, the toluene is removed therefrom to prepare an oily crude product, and the oily crude product is further column-refined with silica gel to crystallize 5.09 g of 2-hydroxy-4′-(di-para-tolylamino)stilbene in hexane at a yield of 72%, having a boiling point of 136.0 to 138.0° C.

(iii) Preparation of 4′-(di-para-tolylamino)stilbene-2-ylacrylate

14.9 g of the 2-hydroxy-4′-(di-para-tolylamino) stilbene. 100 ml of tetrahydrofuran and 21.5 g of sodium hydrogen carbonate solution having a concentration of 12% are put in a reaction reservoir having a mixer, a thermometer and a dropping funnel. Under a nitrogen stream 5.17 g of chloride acrylate is dropped therein for 30 min at 5° C., and the reaction therein is further performed for 3 hrs at the same temperature. The reaction liquid is put in water, extracted with toluene, condensed and column-refined with silica gel to prepare a crude product. The crude product is recrystallized with ethanol to prepare 13.5 g of a yellow needle crystal 4′-(di-para-tolylamino)stilbene-2-ylacrylate (Exemplified Compound No. 2) at a yield of 79.8%, having a boiling point of 104.1 to 105.2° C. The elemental analysis thereof is as follows.

Elemental Analysis Value (%)

| | C | H | N |
|---|---|---|---|
| Found value | 83.46 | 6.06 | 3.18 |
| Calculated value | 83.57 | 6.11 | 3.14 |

2-hydroxybenzylesterphosphonate derivatives and various amino-substituted benzaldehyde derivatives are reacted with each other to synthesize many 2-hydroxystilbene derivatives and various esteracrylate compounds can be synthesized when the 2-hydroxystilbene derivatives are acrylated or methacrylated.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

An undercoat coating liquid, a charge generation coating liquid and charge transport coating liquid, which have the following formulations, are coated and dried in this order on an aluminum cylinder having a diameter of 30 mm to form an undercoat layer 3.0 μm thick, a charge generation layer 0.2 μm thick, a charge transport layer 20 μm thick thereon. The charge transport layer is further coated with a crosslinked surface layer coating liquid having the following formulation by a spray coating method using a spray gun. The spray gun is FSA-G05 from Meiji Machine Co., Ltd and the spray pressure is 0.2 Mpa. A distance between the spray nozzle and the CCL is 2 cm. After spraying, the coating liquid is dried by heating at 80° C. for 5 min, irradiated with a UP lamp system from Ushio, Inc. for 120 sec, and further dried at 130° C. for 15 min to form a crosslinked surface layer 8 μm thick. A shelf drier HPS-222 from Tabai Espec Corp. is used as the heating drier. A gas chromatograph 15-A from Shimadzu Corp. is used to measure a residual solvent concentration from a peak area of the resultant spectrum.

Undercoat Layer Coating Liquid

| | |
|---|---|
| Alkyd resin | 6 |
| (BEKKOZOL 1307-60-EL from Dainippon Ink & | |
| Chemicals, Inc.) | |
| Melamine resin | 4 |
| (SURER BEKKAMIN G-821-60 from Dainippon | |
| Ink & Chemicals, Inc.) | |
| Titanium dioxide powder | 40 |
| Methyl ethyl ketone | 50 |

CGL Coating Liquid

| | |
|---|---|
| Polyvinyl butyral (XYHL from Union Carbide Corp.) | 0.5 |
| (XYHL from Union Carbide Corp.) | |
| Cyclohexanone | 200 |
| Methyl ethyl ketone | 80 |
| Bisazo pigment having the following formula (I): | 2.5 |

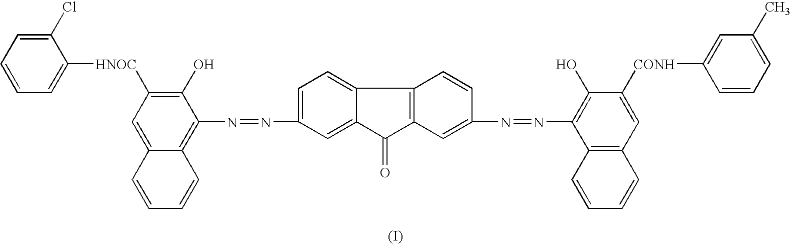

CTL Coating Liquid

| | |
|---|---|
| Bisphenol Z Polycarbonate | 10 |
| (Panlite TS-2050 from TEIJIN CHEMICALS LTD.) | |
| Tetrahydrofuran | 100 |
| 1% tetrahydrofuran solution of silicone oil | 0.2 |
| (KF50-100CS from Shin-Etsu Chemical Industry Co., Ltd.) | |
| Charge transport material having the following formula (II): | 7 |

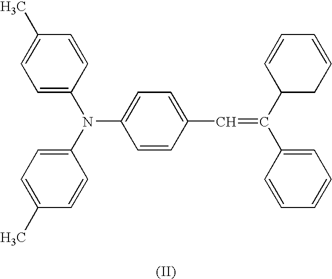

Crosslinked Surface Layer Coating Liquid

| | |
|---|---|
| Monofunctional radical polymerizable compound | 10 |
| having a charge transport structure | |
| (Above-exemplified compound No. 54 having a molecular | |
| weight of 419) | |
| Trifunctional radical polymerizable monomer | 10 |
| having no charge transport structure | |
| (Trimethylolpropanetriacrylate KAYARAD TMPTA having a | |
| molecular weight of 296 from NIPPON KAYAKU CO., LTD.) | |
| Photo polymerization initiator | 1 |
| (IRGACURE 184 having a molecular weight of 204 from Nippon | |
| Kayaku Co., Ltd.) | |
| Tetrahydrofuran | 120 |
| having a boiling point of 66° C. and a saturated vapor | |
| pressure of 176 mm Hg/25° C. | |

### Example 2

The procedure for preparation of the electrophotographic photoreceptor in Example 1 is repeated to prepare an electrophotographic photoreceptor except for changing the distance between the spray nozzle and the CTL to 5 cm to form a crosslinked surface layer.

### Example 3

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the above-exemplified compound No. 150 having a molecular weight of 298.

### Example 4

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the above-exemplified compound No. 141 having a molecular weight of 269.

### Example 5

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the above-exemplified compound No. 109 having a molecular weight of 445.

### Example 6

The procedure for preparation of the electrophotographic photoreceptor in Example 1 is repeated to prepare an electrophotographic photoreceptor except for replacing 120 parts of tetrahydrofuran in the crosslinked surface layer coating liquid to 60 parts thereof and 60 parts cyclohexanone having a boiling point of 156° C. and a saturated vapor pressure of 13 mm Hg/25° C. The residual solvent in the crosslinked surface layer is 4,500 ppm after spraying.

### Example 7

The procedure for preparation of the electrophotographic photoreceptor in Example 1 is repeated to prepare an electrophotographic photoreceptor except for replacing 120 parts of tetrahydrofuran in the crosslinked surface layer coating liquid to 60 parts thereof and 60 parts cyclohexanone having a boiling point of 56° C. and a saturated vapor pressure of 400 mm Hg/25° C. The residual solvent in the crosslinked surface layer is 300 ppm after sprayed.

### Example 8

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the above-exemplified bifunctional compound No. 173 having a molecular weight of 552.

### Example 9

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the above-exemplified trifunctional compound No 165 having a molecular weight of 455.

### Example 10

The procedure for preparation of the electrophotographic photoreceptor in Example 1 is repeated to prepare an electrophotographic photoreceptor except for drying the coating liquid by heating at 100° C. for 5 min after spraying to form a crosslinked surface layer.

### Example 11

The procedure for preparation of the electrophotographic photoreceptor in Example 1 is repeated to prepare an electrophotographic photoreceptor except for changing the distance between the spray nozzle and the CTL to 10 cm and drying the coating liquid by heating at 25° C. for 10 min after spraying to form a crosslinked surface layer.

### Comparative Example 1

The procedure for preparation of the electrophotographic photoreceptor in Example 1 is repeated to prepare an electrophotographic photoreceptor except for replacing the trifunctional radical polymerizable monomer in the crosslinked surface layer coating liquid with bifunctional 1,6-hexanedioldiacrylate having a molecular weight of 226 from Wako Pure Chemical Industries, Ltd., wherein no tri- or more functional radical polymerizable monomer is used.

### Comparative Example 2

The procedure for preparation of the electrophotographic photoreceptor in Example 1 is repeated to prepare an electrophotographic photoreceptor except for excluding the monofunctional radical polymerizable compound having a charge transport structure in the crosslinked surface layer coating liquid, wherein no monofunctional radical polymerizable compound having a charge transport structure is used.

### Comparative Example 3

The procedure for preparation of the electrophotographic photoreceptor in Example 1 is repeated to prepare an electrophotographic photoreceptor except for excluding the trifunctional radical polymerizable monomer and replacing 10 parts of the monofunctional radical polymerizable compound having a charge transport structure in the crosslinked surface layer coating liquid with 20 parts thereof, wherein no tri- or more functional radical polymerizable monomer is used.

### Comparative Example 4

The procedure for preparation of the electrophotographic photoreceptor in Example 1 is repeated to prepare an electrophotographic photoreceptor except for replacing the monofunctional radical polymerizable compound having a charge transport structure in the crosslinked surface layer coating liquid with the following non-radical polymerizable charge transport material: 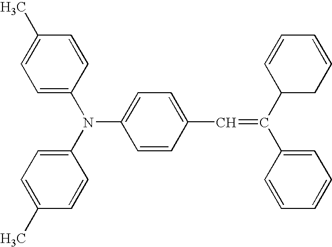
wherein no monofunctional radical polymerizable compound having a charge transport structure is used.

### Comparative Example 5

The procedure for preparation of the electrophotographic photoreceptor in Example 1 is repeated to prepare an electrophotographic photoreceptor except for not forming the crosslinked surface layer and changing the thickness of the CTL to 28 μm.

### Comparative Example 6

The procedure for preparation of the electrophotographic photoreceptor in Example 1 is repeated to prepare an electrophotographic photoreceptor except for drying the coating liquid by heating at 25° C. for 1 min after spraying to form a crosslinked surface layer, which does not satisfy the requirement of layer film density of the present invention.

### Comparative Example 7

The procedure for preparation of the electrophotographic photoreceptor in Example 1 is repeated to prepare an electrophotographic photoreceptor except for forming the crosslinked surface layer having a thickness of 5 μm according to Example 8 in Published Unexamined Japanese Patent Application No. 2004-302451, wherein the coating liquid is dried by heating at 25° C. for 1 min after spraying to form a crosslinked surface layer, which does not satisfy the requirement of layer film density of the present invention.

### Comparative Example 8

The procedure for preparation of the electrophotographic photoreceptor in Example 1 is repeated to prepare an electrophotographic photoreceptor except for forming the crosslinked surface layer having a thickness of 5 μm according to Example 10 in Published Unexamined Japanese Patent Application No. 2004-302452, wherein the coating liquid is dried by heating at 25° C. for 1 min after spraying to form a crosslinked surface layer, which does not satisfy the requirement of layer film density of the present invention.

These photoreceptors are evaluated by the following test methods.

<Crosslinkability>

The crosslinkability of the crosslinked surface layer is evaluated by the solubility thereof in an organic solvent. A drop of tetrahydrofuran is placed on the photoreceptor, and the change of the surface profile after being naturally dried is visually observed. The surface is partially dissolved and has ring-shaped concavities and convexities or clouds when insufficiently hardened.

The results are shown in Table 1.

TABLE 1

| | |
|---|---|
| Example 1 | Insoluble |
| Example 2 | Insoluble |
| Example 3 | Insoluble |
| Example 4 | Insoluble |
| Example 5 | Insoluble |
| Example 6 | Insoluble |
| Example 7 | Insoluble |
| Example 8 | Insoluble |
| Example 9 | Insoluble |
| Example 10 | Insoluble |
| Example 11 | Insoluble |
| Comparative Example 1 | Soluble |
| Comparative Example 2 | Insoluble |
| Comparative Example 3 | Soluble |
| Comparative Example 4 | Soluble |
| Comparative Example 5 | Soluble |
| Comparative Example 6 | Insoluble |
| Comparative Example 7 | Insoluble |
| Comparative Example 8 | Insoluble |

<Layer Film Density>

(1) The weight variation of the crosslinked surface layer before and after forming is measured with an electronic balance AE163 from Mettler-Toledo international Inc. at 22° C. and 55% RH.

(2) The thickness thereof is measured with Fischer Scope MMS from Fischer Instruments K.K. at 22° C. and 55% RH.

(3) The layer film density is determined by dividing the weight of the crosslinked surface layer with the volume thereof based on the thickness.

<Chemical Fatigue>

The photoreceptors are left in an environment having a nitrogen oxide concentration of 20 ppm, a nitrogen dioxide of 5 ppm, a temperature of 25° C. and a humidity of 45% RH for 2 days using a NOx exposer from Dylec Inc.

<Potential>

The photoreceptors are installed in an apparatus disclosed in Published Unexamined Japanese Patent Application No. 60-100167, corona-charged for 20 sec at +6.0 kV and 1,700 rpm and the surface potentials (Vm) thereof are measured before and after exposure to NOx.

The results of Examples 1 to 11 and Comparative Examples 2 and 6 to 8 are shown in Table 2.

TABLE 2

| | Layer Film Density | Vm | |
|---|---|---|---|
| | (g/cm³) | Before exposed | After exposed |
| Example 1 | 1.27 | 1,410 V | 500 V |
| Example 2 | 1.35 | 1,390 V | 650 V |
| Example 3 | 1.28 | 1,400 V | 510 V |
| Example 4 | 1.35 | 1,410 V | 650 V |
| Example 5 | 1.33 | 1,410 V | 640 V |
| Example 6 | 1.05 | 1,370 V | 400 V |
| Example 7 | 1.38 | 1,400 V | 670 V |
| Example 8 | 1.20 | 1,380 V | 470 V |
| Example 9 | 1.15 | 1,390 V | 450 V |
| Example 10 | 1.30 | 1,420 V | 600 V |
| Example 11 | 1.22 | 1,400 V | 520 V |
| Comparative | 1.28 | 1,410 V | 550 V |
| Example 2 | | | |
| Comparative | 0.95 | 1,410 V | 60 V |
| Example 6 | | | |
| Comparative | 0.98 | 1,400 V | 80 V |
| Example 7 | | | |
| Comparative | 0.97 | 1,390 V | 70 V |
| Example 8 | | | |

When the crosslinked surface layer has a layer film density of from 1.0 to 1.4 g/cm³, the influence of the NOx is reduced, i.e., the environmental resistance is improved.

<Image>

The photoreceptors are installed in process cartridges, which are set in imagio Neo 1050 Pro, and images are produced thereby at an initial dark space potential of −800 V to evaluate before and after exposure to NOx.

The results of Examples 1 to 11 and Comparative Examples 2 and 6 to 8 are shown in Table 3.

TABLE 3

| | Before exposed | After exposed |
|---|---|---|
| Example 1 | Good | Good |
| Example 2 | Good | Good |
| Example 3 | Good | Good |
| Example 4 | Good | Good |
| Example 5 | Good | Good |
| Example 6 | Good | Good |
| Example 7 | Good | Good |
| Example 8 | Good | Good |
| Example 9 | Good | Good |
| Example 10 | Good | Good |
| Example 11 | Good | Good |
| Comparative Example 2 | Unformable from the beginning | |
| Comparative Example 6 | Good | Residual images were formed |
| Comparative Example 7 | Good | Residual images were formed |
| Comparative Example 8 | Good | Residual images were formed |

Comparative Example 2 does not form an image from the beginning. Comparative Examples 6 to 8 form residual images after exposure to NOx. On the contrary, the photoreceptors of the present invention, having environmental resistance produce quality images without producing residual images.

This application claims priority and contains subject matter related to Japanese Patent Application No. 2006-066947 filed on Mar. 13, 2006, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An electrophotographic photoreceptor, comprising:
an electroconductive substrate, and
a photosensitive layer located overlying the electroconductive substrate, wherein the photosensitive layer comprises units obtained from:
a tri- or more functional radical polymerizable monomer having no charge transport structure; and
a radical polymerizable compound having a charge transport structure,
wherein the photosensitive layer has a layer film density of from 1.0 to 1.4 g/cm³.

2. The electrophotographic photoreceptor of claim 1, wherein the charge transport structure is at least one member selected from the group consisting of triarylamine structures, hydrazone structures, pyrazoline structures and carbazole structures.

3. The electrophotographic photoreceptor of claim 1, wherein the charge transport structure is a triarylamine structure.

4. The electrophotographic photoreceptor of claim 1, wherein the radical polymerizable compound having a charge transport structure has a functional group selected from the group consisting of acryloyloxy groups and methacryloyloxy groups.

5. The electrophotographic photoreceptor of claim 1, wherein the radical polymerizable compound having a charge transport structure is monofunctional.

6. The electrophotographic photoreceptor of claim 1, wherein the tri- or more functional radical polymerizable monomer having no charge transport structure has three or more functional groups selected from the group consisting of acryloyloxy groups and methacryloyloxy groups.

7. The electrophotographic photoreceptor of claim 1, wherein the tri- or more functional radical polymerizable monomer having no charge transport structure and the radical polymerizable compound having a charge transport structure are polymerized by the application of heat or light energy.

8. A method of preparing the electrophotographic photoreceptor according to claim 1, comprising:
coating the electroconductive substrate with a liquid comprising the tri- or more functional radical polymerizable monomer having no charge transport structure, the radical polymerizable compound having a charge transport structure and a solvent; and
polymerizing the tri- or more functional radical polymerizable monomer having no charge transport structure and the radical polymerizable compound having a charge transport structure,
wherein the photosensitive layer includes a residual solvent not greater than 5,000 ppm when the polymerizing starts.

9. The method of claim 8, further comprising:
de-solventing the photosensitive layer before the polymerizing.

10. The method of claim 9, wherein the de-solventing is performed by drying by heating.

11. The method of claim 10, wherein the drying by heating is performed at from 20 to 170° C.

12. The method of claim 8, wherein the coating of the electroconductive substrate is performed by spray coating.

13. An image forming method, comprising:
charging the electrophotographic photoreceptor according to claim 1;
irradiating the electrophotographic photoreceptor to form an electrostatic latent image thereon;
developing the electrostatic latent image with a toner to form a toner image thereon; and
transferring the toner image onto a receiving material.

14. An electrophotographic image forming apparatus comprising:
the electrophotographic photoreceptor according to claim 1;
a charger configured to charge the electrophotographic photoreceptor;
an irradiator configured to irradiate the electrophotographic photoreceptor with light to form an electrostatic latent image on the photoreceptor;
an image developer configured to develop the electrostatic latent image with a toner to form a toner image on the electrophotographic photoreceptor; and
a transferer configured to transfer the toner image onto a receiving material.

15. A process cartridge detachable from an image forming apparatus comprising:
the electrophotographic photoreceptor according to claim 1; and
at least one of a charger, an image developer, a transferer, a cleaner and a discharger.
